(19) United States
(12) Patent Application Publication
(10) Pub. No.: US 2009/0205116 A1
(43) Pub. Date: Aug. 20, 2009

(54) ARTICLE, LAMINATE AND ASSOCIATED METHODS

(75) Inventors: Joshua J. Stone, Worcester, NY (US); Vishal Bansal, Overland Park, KS (US); Ryan Austin Hutchinson, Albany, NY (US); Gary Charles Davis, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/329,414

(22) Filed: Dec. 5, 2008

Related U.S. Application Data
(63) Continuation-in-part of application No. 11/863,469, filed on Sep. 28, 2007.
Application No. 11/863,469 is a continuation-in-part of application No. 11/241,227, filed on Sep. 30, 2005, now Pat. No. 7,381,331.

(51) Int. Cl. A41D 13/00; B32B 3/26; B05D 3/10; A41D 1/00; A43B 1/00

(52) U.S. Cl. 2/455; 428/305.5; 427/2.31; 2/69; 36/83

(57) ABSTRACT

An article includes a membrane having pores and a selectively permeable coating supported by the membrane. The selectively permeable coating includes an antimicrobial agent in an amount that is sufficient to chemically react with a chemical or microbial agent to reduce the biological activity of the chemical or microbial agent or increase an amount of time for a significant amount of unreacted biologically active chemical or microbial agent to pass through the article. A laminate and methods of providing these are also provided.

### CROSS REFERENCE TO RELATED APPLICATIONS

This application is a continuation-in-part of U.S. patent application Ser. No. 11/863,469, entitled “Article and Associated Method”, filed Sep. 28, 2007, which in turn is a continuation-in-part of U.S. patent application Ser. No. 11/241,227, entitled “Hydrophilic Membrane and Associated Method”, filed Sep. 30, 2005, and which issued on Jun. 3, 2008 as U.S. Pat. No. 7,381,331. This application claims priority to and benefit from the foregoing applications, the disclosures of which are incorporated herein by reference.

### STATEMENT REGARDING FEDERALLY SPONSORED RESEARCH & DEVELOPMENT

This invention was made with Government support under contract number W911QY-05-C-0102 awarded by US Army Natick Soldier Research Development and Engineering Center, Natick Mass. The Government has certain rights in the invention.

### BACKGROUND

Membranes with high porosity, chemical resistance, and having selective permeability to chemical or biological agents are useful in high performance applications, such as in the manufacture of garments that provide protection against chemical and biological agents. In addition to their protective properties, such garments are also desirably comfortable to wear in a variety of environments, and while undertaking a variety of activities.

Expanded polytetrafluoroethylene (ePTFE) has been used as a selectively permeable membrane in applications wherein chemical and/or temperature resistance, or high airflow through the membrane, is/are desired or required. However, currently commercially available selectively permeable protection systems based ePTFE typically may not provide protection against secondary exposure, i.e., exposure that may occur should the chemical or biological agent be trapped within the system, but not neutralized or deactivated. Furthermore, these conventional protection systems based upon ePTFE may typically have low moisture vapor transport rate (MVTR) and thus be uncomfortable for use in hot, humid environments. Additionally, many of these also are treated with materials, or layers of materials to provide the garments with their protective properties and as a result, may be bulky or be completely impermeable to water vapor, further reducing the comfort associated with their wear.

It would thus be desirable to provide highly effective protective articles, and due to its many advantageous properties protective articles based upon ePTFE, that are not only effective against a broader spectrum of possible exposure venues than currently available, but also, that are more comfortable to use. Different methods of production than those currently available may also assist in the provision of such articles.

### BRIEF DESCRIPTION

In one embodiment, an article is provided. The article includes a membrane having pores and a selectively permeable coating supported by the membrane. The selectively permeable coating comprises at least one antimicrobial agent in an amount that is sufficient to inactivate, or reduce the activity of, a chemical or microbial agent, or slow the migration of a chemical or microbial agent through the article.

In another embodiment, an article is provided. The article comprises a membrane having pores. A selectively permeable coating is supported by the membrane, and comprises an effective amount of at least one antimicrobial agent and an amine or imine-containing polymer

In a further embodiment, a laminate is provided. The laminate comprises an article, the article further comprising a membrane having pores and a selectively permeable coating supported by the membrane. The selectively permeable coating comprises at least one antimicrobial agent in an amount that is sufficient to inactivate, or reduce the activity of, a chemical or microbial agent, or slow the migration of a chemical or microbial agent through the article. The laminate further comprises an oleophobic membrane, wherein the article is supported on the oleophobic membrane.

In yet another embodiment, a method is provided. The method includes applying a selectively permeable coating to a porous membrane, wherein the selectively permeable coating comprises at least one antimicrobial agent in an amount that is sufficient to inactivate, or reduce the activity of, a chemical or microbial agent, or to slow the migration of a chemical or microbial agent through the article.

### DRAWINGS

These and other features, aspects, and advantages of the present invention will become better understood when the following detailed description is read with reference to the accompanying drawings in which like characters represent like parts throughout the drawings, wherein:

FIG. 1 shows a cross-section of an article in accordance with one embodiment of the invention;

FIG. 2 shows a cross-section of an article in accordance with one embodiment of the invention;

FIG. 3 shows a cross-section of an article in accordance with one embodiment of the invention;

FIG. 4 shows a cross-section of a laminate in accordance with one embodiment of the invention;

FIG. 5 shows a cross-section of a laminate in accordance with one embodiment of the invention;

FIG. 6 shows a cross-section of a laminate in accordance with one embodiment of the invention;

FIG. 7 shows a cross-section of a laminate in accordance with one embodiment of the invention;

FIG. 8 shows a cross-section of a laminate in accordance with one embodiment of the invention;

FIG. 9 shows a cross-section of a laminate in accordance with one embodiment of the invention;

FIG. 10 shows a cross-section of a laminate in accordance with one embodiment of the invention; and

FIG. 11 shows a cross-section of a laminate in accordance with one embodiment of the invention.

### DETAILED DESCRIPTION

The invention includes embodiments that relate to articles comprising a porous membrane supportive of a selectively permeable coating as well as laminates comprising the articles and methods of making and using the articles.

In the following specification and the clauses which follow, reference will be made to a number of terms having the following meanings. The singular forms “a”, “an” and “the” include plural referents unless the context clearly dictates otherwise. Approximating language, as used herein throughout the specification and clauses, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

In one embodiment, an article is provided. An article includes a membrane having pores and a selectively permeable coating supported by the membrane. The selectively permeable coating comprises at least one antimicrobial agent in an amount that is sufficient to inactivate, or reduce the activity of, a chemical or microbial agent, or to slow the migration of a chemical or microbial agent through the article.

Suitable membranes may include one or more of polyalkylene, polyarylene, polyamide, polyester, polysulfone, polyether, polyacrylic, polystyrene, polyurethane, polyarylate, polyimide, polycarbonate, polysiloxane, polyphenylene oxide, cellulosic polymer, or substituted derivatives thereof. In some embodiments, the membrane includes a biocompatible material or a biodegradable material, such as aliphatic polyesters, polypeptides and other naturally occurring polymers.

In one embodiment, the membrane may comprise a fluorinated polymer. As used herein, the phrase “fluorinated polymer” refers to a polymer in which some or all of the hydrogen atoms are replaced by fluorine. In one embodiment, the membrane may comprise a fluorinated polyolefin. As used herein, the term “fluorinated polyolefin” refers to a fluorinated polymer derived from one or more fluorinated polymer precursors containing ethylenic unsaturation. A suitable fluorinated polymer precursor may be a partially fluorinated olefin which may include other substituents, e.g. chlorine or hydrogen. A suitable fluorinated polymer precursor may be a straight or branched chain compound having a terminal ethylenic double bond. In one embodiment, a suitable polymer precursor may include one or more of hexafluoropropylene, pentafluoropropylene, tetrafluoroethylene, vinylidine fluoride, or perfluoroalkyl vinyl ethers, for example, perfluoro (methyl vinyl ether) or (propyl vinyl ether).

In one embodiment, a fluorinated polyolefin essentially includes one or both of polyvinylidene fluoride or polytetrafluoroethylene. In one embodiment, a fluorinated polyolefin essentially includes expanded polytetrafluoroethylene (ePTFE). Suitable ePTFE membranes include those commercially obtainable from General Electric Energy (Kansas City, Mo.).

In one embodiment, the membrane may be made by extruding a mixture of fine powder particles and lubricant. The extrudate subsequently may be calendered. The calendered extrudate may be “expanded” or stretched in one or more directions, to form fibrils connecting nodes to define a three-dimensional matrix or lattice type of structure. “Expanded” means stretched beyond the elastic limit of the material to introduce permanent set or elongation to fibrils. The membrane may be heated or “sintered” to reduce and minimize residual stress in the membrane by changing portions of the membrane material from a crystalline state to an amorphous state. In one embodiment, the membrane may be unsintered or partially sintered as is appropriate for the contemplated end use of the membrane. In one embodiment, the membrane may define many interconnected pores that fluidly communicate with environments adjacent to the opposite facing major sides of the membrane.

Other materials and methods may be used to form the membrane having an open pore structure. The membrane may be rendered permeable by, for example, one or more of perforating, stretching, expanding, bubbling, precipitating or extracting the base membrane. Suitable methods of making the membrane include foaming, skiving or casting any of the suitable materials. In alternate embodiments, the membrane may be formed from woven or non-woven fibers.

In certain embodiments, the membrane may be provided with relatively continuous pores. Whether relatively continuous and/or substantially discontinuous, suitable porosities of the membrane may be in a range of greater than about 10 percent by volume. In one embodiment, the porosity may be in a range of from about 10 percent to about 20 percent, from about 20 percent to about 30 percent, from about 30 percent to about 40 percent, from about 40 percent to about 50 percent, from about 50 percent to about 60 percent, from about 60 percent to about 70 percent, from about 70 percent to about 80 percent, from about 80 percent to about 90 percent, or greater than about 90 percent by volume. Here and throughout the specification and claims, range limitations may be combined and/or interchanged. Such ranges are identified by their range limitations, and include all the sub-ranges therebetween.

The pore diameter of the pores within the membrane may be uniform from pore to pore, and/or the pores may define a predetermined pattern. Alternatively, the pore diameter may differ from pore to pore, and/or the pores may define an irregular pattern. Suitable pore diameters may be less than about 500 micrometers. In one embodiment, an average pore diameter may be in a range of from about 1 micrometer to about 10 micrometers, from about 10 micrometers to about 50 micrometers, from about 50 micrometers to about 100 micrometers, from about 100 micrometers to about 250 micrometers, or from about 250 micrometers to about 500 micrometers. In one embodiment, the average pore diameter may be less than about 1 nanometer, in a range of from about 1 nanometer to about 50 nanometers, from about 50 nanometers to about 0.1 micrometers, from about 0.1 micrometers to about 0.5 micrometers, or from about 0.5 micrometers to about 1 micrometer. In one embodiment, the average pore diameter may be less than about 1 nanometer. In one embodiment, the pores may essentially have an average pore diameter in a range of from about 10 nanometers to about 10 micrometers.

The average effective pore size of pores in the membrane may be in the micrometer range. In other embodiments, the average effective pore size of pores in the membrane may be in the nanometer range. A suitable average effective pore size for pores in the membrane may be in a range of from about 0.01 micrometers to about 0.1 micrometers, from about 0.1 micrometers to about 5 micrometers, from about 5 micrometers to about 10 micrometers, or greater than about 10 micrometers.

In one embodiment, the membrane may be a three-dimensional matrix or have a lattice type structure including plurality of nodes interconnected by a plurality of fibrils. Surfaces of the nodes and fibrils may define a plurality of pores in the membrane. The size of a fibril may be in a range of from about 0.05 micrometers to about 0.5 micrometers in diameter taken in a direction normal to the longitudinal axis of the fibril. The specific surface area of the membrane may be in a range of from about 9 square meters per gram of membrane material to about 110 square meters per gram of membrane material.

Membranes according to embodiments of the invention may have differing dimensions, some selected with reference to application-specific criteria. In one embodiment, the membrane may have a thickness in the direction of fluid flow in a range of less than about 10 micrometers. In another embodiment, the membrane may have a thickness in the direction of fluid flow in a range of greater than about 10 micrometers, for example, in a range of from about 10 micrometers to about 100 micrometers, from about 100 micrometers to about 1 millimeter, from about 1 millimeter to about 5 millimeters, or greater than about 5 millimeters. In one embodiment, the membrane may have an average thickness in a range of from about 0.0005 inches (12.7 micrometers) to about 0.005 inches (127 micrometers). In one embodiment, the membrane may be formed from a plurality of layers of the same, or differing, thickness.

Perpendicular to the direction of fluid flow, the membrane may have a width of greater than about 10 millimeters. In one embodiment, the membrane may have a width in a range of from about 10 millimeters to about 45 millimeters, from about 45 millimeters to about 50 millimeters, from about 50 millimeters to about 10 centimeters, from about 10 centimeters to about 100 centimeters, from about 100 centimeters to about 500 centimeters, from about 500 centimeters to about 1 meter, or greater than about 1 meter. The width may be a diameter of a circular area, or may be the distance to the nearest peripheral edge of a polygonal area. In one embodiment, the membrane may be rectangular, having a width in the meter range and an indeterminate length. That is, the membrane may be formed into a roll with the length determined by cutting the membrane at predetermined distances during a continuous formation operation.

In one embodiment, the membrane may have a unit average weight in a range of less than about 0.05 oz/yd². In one embodiment, the membrane may have a unit average weight in a range of from about 0.05 oz/yd² to about 0.1 oz/yd², from about 0.1 oz/yd² to about 0.5 oz/yd², from about 0.5 oz/yd² to about 1 oz/yd², from about 1 oz/yd² to about 2 oz/yd², or from about 2 oz/yd² to about 3 oz/yd².

The desired membrane is supportive of a selectively permeable coating. “Selectively permeable” as used herein refers to a coating that possesses significantly differing permeabilities to desired chemical penetrants (for example, water vapor) relative to undesired chemical penetrants (for example, chembio or microbial agents). In some embodiments, selectively permeable coatings may provide the underlying membranes with a permeability to water vapor versus the permeability to a chembio or microbial agent that is greater by a factor of about 5, or greater by a factor in a range of from about 5 to about 10, from about 10 to about 50, from about 50 to about 100, from about 100 to about 500, or from about 500 to about 1000. Desirably, the permeability to water vapor would be so much greater than the permeability to chemical or microbial agents, which itself would desirably be zero, so that this factor would approximate infinity.

The selectively permeable coating comprises an effective amount of at least one antimicrobial agent. The antimicrobial agent may be any agent that reduces or eliminates the activity of a chembio or microbial agent, or the ability of a chembio or microbial agent to migrate through an article comprising the antimicrobial agent. These include, but are not limited to halamines; quaternary ammonia compounds such as alkylbenzyldimethyl benzalkonium chloride; silver ion containing compounds; sulfonamides such as benzenesulfonamide; N-chloro-4-methyl-, sodium salt; zinc ion containing compounds such as zinc pyrithiones, 2-mercaptobenzothiazole, zinc salt and zinc sulfate; copper ion containing compounds such as copper oxide, copper thiocyanate, and copper sulfate; chlorine releasing compounds such as hypochlorite, sodium dichloro-s-triazinetrione, trichloro-s-triazinetrione, or combinations of these.

Other particular antimicrobial agents, that may also exhibit activity against chembio agents, include, but are not limited to, (1,1′-biphenyl)-2-ol; carbamic acid, 1H-benzimidazol-2-yl, methyl ester; 2(1H)-pyriddinethione, 1-hydroxy-, zinc salt; Ethyl Ziram; thiocyanic acid, (2-benzothiazoylthio)methyl ester; tetrahydro-3,5-dimethyl-2H-1,3,5-thiadiazine-2-thione; thiocyanic acid (2-benzothiazolylhio)methyl ester; carbamodithioi acid, dimethyl-, potassium salt; carbamodithioi acid, dimethyl-, sodium salt; thiocyanic acid, methylene ester; thiocyanic acid, (2-benzothiazolylhio)methyl ester; K—N-hydroxymethyl-N-methyldithiocarbonate; 2(3H)-benzothiazolethione, sodium salt; carbamic acid, [1-((butylamino)carbonyl)-1H-benzimidiazol-2-yl]-, methyl ester; benzene, 1-[(diiodomethyl)sulfonyl]-4-methyl-; 3(2H)-isothiazolone, 2-octyl-; formaldehyde, thioperoxydicarbonic diamide; carbamodithioic acid, dimethyl-, sodium salt; tetramethyl thiuramidisulfide; thioperoxydicarbonic diamide([(H₂N)C(S)]₂S₂), tetramethyl-; zinc, bis(dimethylcarbamodithioato-S,S′; 2-mercaptobenzothiazole, zinc salt; 2(3H)-benzothiazolethione; zinc oxide; 2(3H)-benzothiazolethione, sodium salt; formaldehyde; thioperoxydiocarbonic diamide; 3(2H)-isothiazolone, 2-methyl-; 2(1H)-pyridinethione, 1-hydroxy-zinc salt; 3(2H)-isothiazolone, 5-chloro-2-methyl-; borax decahydrate; sulfuric acid diammonium salt; boric acid; boron acid; ammonium phosphate; ammonium sulphate or combinations of these.

In one embodiment, the antimicrobial agent may comprise a halamine having any of the following structures (1)-(10):

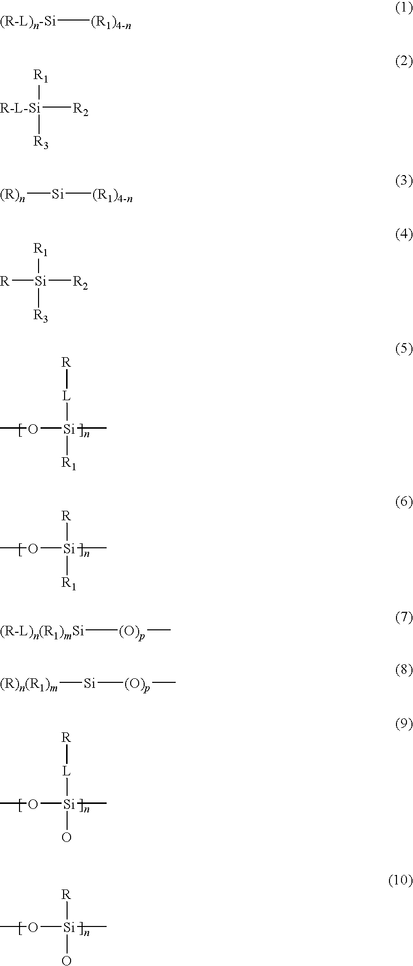

For structures (1)-(8) above, R₁, R₂, and R₃ are independently selected from a C₁-C₄ alkyl, aryl, C₁-C₄ alkoxy, hydroxyl, chloro, or C₁-C₄ ester group, wherein at least one of R₁, R₂, or R₃ is a C₁-C₄ alkoxy, hydroxyl, chloro, or C₁-C₄ ester group; m=0, 1 or 2; n=1, 2, or 3 for structures (1), (3), (7), and (8); p=1, 2, or 3; m+n+p=4; and R is defined below.

L is a linker group that may be utilized to attach R to the Si moiety. In certain embodiments, L is a alkylene, amine or ether group, comprised of 1-13 carbons, 0-3 nitrogen or oxygen atoms, and in others, L is a alkylene group of 1-13 carbons and a carbamate, thiocarbamate, or urea functional group.

R groups suitable for structures (1), (2), (5), (7), and (9) above have the following structures (11)-(21):

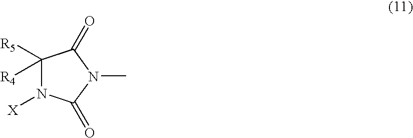

Wherein R₄ and R₅ are independently selected from a C₁-C₄ alkyl, aryl, or hydroxymethyl group; and wherein X is chlorine or bromine. X can also be hydrogen if the compound is represented by structures (5), a siloxane, or (9), a modified substrate.

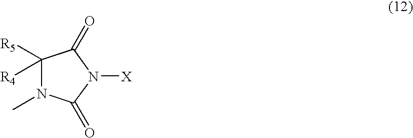

Wherein R₄ and R₅ are independently selected from a C₁-C₄ alkyl, aryl, or hydroxymethyl group; and wherein X is hydrogen, chlorine or bromine.

Representative compounds according to structures (1), (2), (5), (7), and (9) wherein R comprises groups (11) or (12) are those wherein R₁, R₂, and R₃ are independently selected from a methyl, ethyl, phenyl, methoxy, ethoxy, or hydroxy group, and wherein R₄ and R₅ are independently selected from a methyl, ethyl, hydroxymethyl or phenyl group.

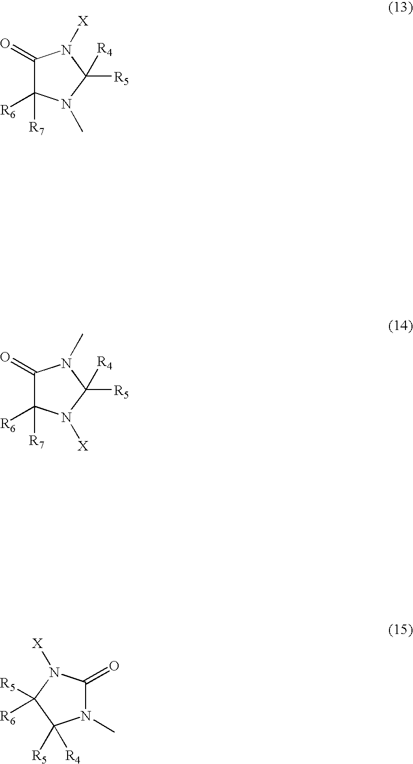

Wherein R₄, R₅, R₆, and R₇ are independently selected from a C₁-C₄ alkyl, aryl, or hydroxymethyl group; and wherein X is hydrogen, chlorine, or bromine.

Representative compounds according to structures (1), (2), (5), (7), and (9) wherein R comprises groups (13), (14) or (15) are those wherein R₁, R₂, and R₃ are independently selected from a methoxy, ethoxy, or hydroxy group, and wherein R₄, R₅, R₆ and R₇ are a methyl group; and L is an alkylene, amine, or ether group, comprised of 1-4 carbons, and 0-1 nitrogen or oxygen atoms, in other embodiments, L is an alkylene group, comprised of 1-4 carbons, and a carbamate, thiocarbamate, or urea functional group.

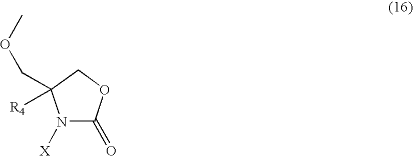

Wherein R₄ is at least one of a C₁-C₄ alkyl, aryl, or hydroxymethyl group; and wherein X is hydrogen, chlorine, or bromine.

Representative compounds according to structures (1), (2), (5), (7), and (9) wherein R comprises group (16) are those wherein R₁, R₂, and R₃ are independently selected from a methoxy, ethoxy, or hydroxy group, and wherein R₄ is a methyl ethyl, or hydroxymethyl group; and L is an alkylene group, comprised of 1-3 carbons, or L is an alkylene group, comprised of 1-3 carbons, and a carbamate, thiocarbamate, or urea functional group.

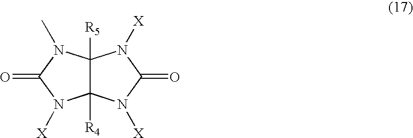

Wherein R₄ and R₅ are independently selected from a C₁-C₄ alkyl, aryl, or hydroxymethyl group; and wherein X is independently selected from hydrogen, chlorine, bromine, or hydroxymethyl; and wherein at least one X is hydrogen, chlorine, or bromine.

Representative compounds according to structures (1), (2), (5), (7), and (9) wherein R comprises group (17) are those wherein R₁, R₂, and R₃ are a methoxy, ethoxy, or hydroxy group, and wherein R₄ is a methyl, ethyl, or hydroxymethyl group; and L is an alkylene group, comprised of 1-3 carbons, or L is an alkylene group, comprised of 1-3 carbons, and a carbamate, thiocarbamate, or urea functional group.

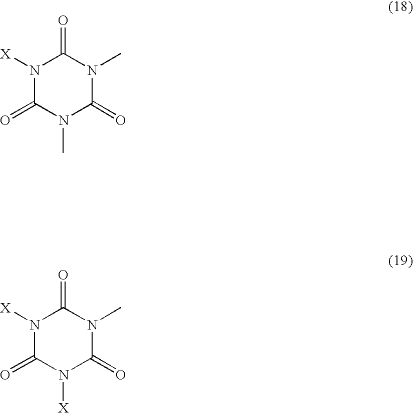

Wherein X is independently selected from hydrogen, chlorine, bromine, or hydroxymethyl; and wherein at least one X is hydrogen, chlorine, or bromine.

Representative compounds according to structures (1), (2), (5), (7), and (9) wherein R comprises group (18) or (19) are those wherein R₁, R₂, and R₃ are a methoxy, ethoxy, or hydroxy group, and L is an alkylene, amine, or ether group, comprised of 1-4 carbons and 0-1 nitrogen or oxygen atoms, or L is an alkylene group, comprised of 1-4 carbons, and a carbamate, thiocarbamate, or urea functional group.

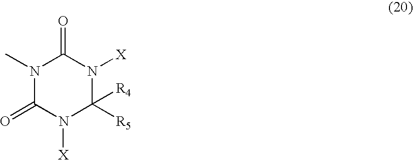

Wherein R₄ and R₅ are independently selected from a C₁-C₄ alkyl, aryl, or hydroxymethyl group; and wherein X is independently selected from hydrogen, chlorine, bromine, or hydroxymethyl; and wherein at least one X is hydrogen, chlorine, or bromine.

Representative compounds according to structures (1), (2), (5), (7), and (9) wherein R comprises group (20) are those wherein R₁, R₂, and R₃ are independently selected from a methoxy, ethoxy, or hydroxy group; R₄ and R₅ are a methyl group; and L is an alkylene, amine or ether group, comprised of 1-4 carbons and 0-1 nitrogen or oxygen atoms, or L is an alkylene group, comprised of 1-4 carbons, and a carbamate, thiocarbamate, or urea functional group.

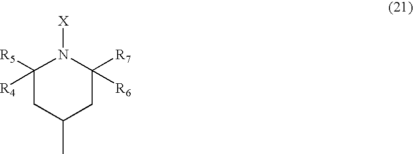

Wherein R₄, R₅, R₆ and R₇ are independently selected from a C₁-C₄ alkyl, aryl, or hydroxymethyl group; and wherein X is chlorine or bromine when on structure (1) or (2), but X is hydrogen, chlorine, or bromine wherein on structures (5), (7), or (9).

Representative compounds according to structures (1), (2), (5), (7), and (9) wherein R comprises group (21) are those wherein R₁, R₂, and R₃ are independently selected from a methoxy, ethoxy, or hydroxy group; R₄, R₅, R₆ and R₇ are a methyl group; and L is an alkylene, amine or ether group, comprised of 1-4 carbons and 0-1 nitrogen or oxygen atoms, or L is an alkylene group, comprised of 1-4 carbons, and a carbamate, thiocarbamate, or urea functional group.

R groups suitable for structures (3), (4), (6), (8), and (10) are an amino alkylene or a polyamino alkylene group comprising at least one N-chloro or N-bromo group. One representative R group for structures (3), (4), (6), (8), and (10) is an amino propyl group.

For groups (5), (6), (9) and (10), n is the number of repeating units, not to be confused with n of structures of (1), (3), (6) and (7) where n is the number of R moieties on Si. The repeating number of units n is greater than or equal to 2, however, n can be as much as 500 or greater. Suitable halamines and derivatives thereof may be obtained commercially from Vanson Halosource, Incorporated (Redmond, Wash.).

In other embodiments of the invention, the antimicrobial agent may comprise one or more quaternary ammonium salts. Many of these are known and/or commercially available, and any capable of acting as an antimicrobial agent are suitable for use in the present selectively permeable coatings. Of these, silicon-containing quaternary ammonium salts, such as those having the following formula (22) may desirably be used as the antimicrobial agent in certain embodiments of the invention:

R₃N⁺R⁰ₙSiX₄₋ₙY⁻ (22)

Wherein each R and each R⁰ is independently a non-hydrolysable organic group; each X is, independently, a hydrolysable group; n is an integer of 0 to 3; and Y⁻ is a suitable anionic moiety to form the salt of the compound of Formula I. Y⁻ may be a halide in some embodiments. In some embodiments, two of the Rs may be methyl and one R may be octadecyl. In one embodiment, R⁰ is propenyl, each X may be a methoxy, n may be 1 and Y may be chloride. One exemplary silicon-containing quaternary ammonium monomer according to Formula 22 is 3-(trimethoxysilyl) propyldimethyloctadecyl ammonium chloride.

Such silicon-containing quaternary ammonium antimicrobial agents may typically be manufactured and supplied in solvents, such as, e.g., methanol. The use of such solvents may allow the silicon-containing quaternary ammonium salts to be adsorbed by the membrane so that an interpenetrating network may be formed within the pores thereof.

In additional embodiments of the invention, the silicon-containing quaternary ammonium salt monomer of Formula (22) may be used to make an antimicrobial polymer comprising repeating units of Formula (23):

R₃N⁺R⁰ₙSiX¹₄₋ₙY⁻ (23)

Wherein each R and each R⁰ is independently a non-hydrolysable organic group, such as, without limitation, an alkyl group of 1 to about 22 carbon atoms or an aryl group, for example, phenyl; each X¹ is —OR¹, —OH or —O—Si, wherein R¹ is an alkyl group of 1 to about 22 carbon atoms, or an aryl group of 6 carbon atoms; n is an integer of 0 to 3; and Y is an anionic moiety suitable to form the salt of the repeating units of Formula (23), such as halide, hydroxyl, acetate, SO₄⁻², CO₃⁻² and a PO₄⁻² counter ion. In some embodiments, Y is a halide. In some embodiments, each of the R groups is independently methyl, ethyl, propyl, butyl, octyl, dodecyl, tetradecyl or octadecyl; each of the R⁰ groups is independently methylenyl, ethylenyl, propylenyl, butylenyl, octylenyl, dodecylenyl, tetradecylenyl or octadecylenyl; and each X¹ is —OR¹, wherein R¹ is methyl, ethyl, propyl or butyl.

The quaternary ammonium salt monomer may also be according to formulas (24) and (25) in some embodiments:

(R¹)₃SiR²N⁺(R³)(R⁴)(R⁵)Y⁻ (24)

(R¹)₃SiR²N(R³)(R⁴) (25)

Wherein each R¹ is independently halogen or R⁶⁰, wherein R⁶ is H, alkyl of 1 to about 22 carbon atoms, acetyl, acetoxy, acyl, propylene glycol, ethylene glycol, polyethylene glycol, polypropylene glycol; a block polymer or copolymer of ethylene and propylene glycol, an alkyl monoether of 1 to about 22 carbon atoms of propylene glycol, ethylene glycol, polyethylene glycol, polypropylene glycol; a block polymer or copolymer of ethylene and propylene glycol or the monoester of a carbonic acid of 1 to about 22 carbon atoms and propylene glycol, ethylene glycol, polyethylene glycol, polypropylene glycol; a block polymer or copolymer of ethylene and propylene glycol; octylphenol; nonylphenol; or sorbitan ether;

R² is benzyl, vinyl, or alkyl of 1 to about 22 carbon atoms;

R³ and R⁴ are, independently, lower alkyl alcohol of 1 to about 6 carbon atoms, lower alkoxy of 1 to about 6 carbon atoms, alkyl of 1 to about 22 carbon atoms, or R³ and R⁴ can, together form a morpholine or cyclic or heterocyclic, unsaturated or saturated, five to seven-member ring of Formula (26):

—R³—(R⁷)ₖ—R⁴— (26)

wherein k is an integer from 0 to 2,

Wherein R⁷, where the ring is saturated, is CH₂, O, S, NH, NH₂⁺, NCH₂CH₂NH₂, NCH₂CH₂NH₃⁺, NCH₂CH₂N(R⁸)(R⁹), NCH₂CH₂N⁺(R⁸)(R⁹)(R¹⁰), N(alkyl), N(aryl), N(Benzyl), wherein each R⁸, R⁹, and R¹⁰ is, independently, benzyl, polyether, lower alkyl alcohol of 1 to 4 carbon atoms, lower alkoxy of 1 to 4 carbon atoms, or alkyl of 1 to about 22 carbon atoms, and wherein R⁷, where the ring is unsaturated, is CH, N, N⁺H, N⁺(alkyl), N⁺(aryl), N⁺(benzyl), NCH₂N, N⁺HCH₂N, N⁺(alkyl)CH₂N, N⁺(aryl)CH₂N, or N⁺(Benzyl)CH₂N;

Wherein the ring is unsubstituted or substituted with alkyl of 1 to 22 carbon atoms, ester, aldehyde, carboxylate, amide, thio-amide, nitro, amine, or halide;

R⁵ is lower alkyl alcohol of 1 to 6 carbon atoms, CH₂C₆H₅, polyether, alkyl, alkoxy, perfluoroalkyl, perfluoroalkylsulfonate or perfluoroalkylcarboxylate, wherein the alkyl alkoxy, perfluoroalkyl, perfluoroalkylsulfonate or perfluoroalkylcarboxylate is of 1 to about 22 carbon atoms, or is a five to seven-member ring of Formula V as described above; and

Y⁻ is a suitable anionic moiety to form the salt of the compound of Formula (24) or (25), and preferably, chloride, bromide or iodide.

Particular examples of silicon-containing quaternary ammonium salt repeating units include those where two of the Rs are methyl and one R is octadecyl, R⁰ is propenyl, n is 1 and Y is chloride, such that the polymer is polymeric 3-(trimethoxysilyl) propyldimethyloctadecyl ammonium chloride. Another example of a useful polymeric silicon-containing quaternary ammonium salt is octadecylaminodimethyltrimeth-oxysilylpropyl ammonium chloride. These and other quaternary ammonium salts useful as the antimicrobial agent in certain embodiments of the invention are commercially available from BIOSAFE, Inc., Pittsburgh, Pa.

One method of making the silicon-containing quaternary ammonium polymer includes adding with agitation the silicon-containing monomer to an excess of solvent, such as water, along with heat and/or a catalyst such as a mineral or organic acid or base, which initiates the polymerization process. The polymer is recovered from resulting precipitation or solvent removal.

Whatever the antimicrobial agent, it will desirably be present in an effective amount. An effective amount of the antimicrobial agent refers to an amount of the antimicrobial agent that is sufficient to inactivate, or reduce the activity of, a chemical or microbial agent, or to slow the migration of a chemical or microbial agent through the article. Desirably, the amount of the antimicrobial agent utilized will also allow the underlying membrane and/or article to meet the performance requirements of the end-use application. In one embodiment, the antimicrobial agent may be present in an amount that is less than about 0.1 weight percent of the combined weight of the membrane and the selectively permeable coating.

In one embodiment, the antimicrobial agent may be present in a range of from about 0.1 weight percent to about 1 weight percent, from about 1 weight percent to about 2 weight percent, from about 2 weight percent to about 5 weight percent, from about 5 weight percent to about 10 weight percent of the combined weight of the membrane and the selectively permeable coating. In one embodiment, the antimicrobial agent may be present in an amount in a range of from about 10 weight percent to about 20 weight percent, from about 20 weight percent to about 30 weight percent, from about 30 weight percent to about 40 weight percent, or from about 40 weight percent to about 50 weight percent of the combined weight of the membrane and the selectively permeable coating. In one embodiment, the antimicrobial agent may be present in an amount that is greater than about 50 weight percent of the combined weight of the membrane and the selectively permeable coating. In one embodiment, the antimicrobial agent may be present is present in an amount in a range of from about 0.1 weight percent to about 20 weight percent of the combined weight of the membrane and the selectively permeable coating.

In one embodiment, the antimicrobial agent may be present in the article in an amount in a range of from about 0.1 mg/cm² to about 0.5 mg/cm², from about 0.5 mg/cm² to about 1 mg/cm², from about 1 mg/cm² to about 2 mg/cm², from about 2 mg/cm² to about 5 mg/cm², from about 5 mg/cm² to about 10 mg/cm², from about 10 mg/cm² to about 25 mg/cm², or from about 25 mg/cm² to about 50 mg/cm² 50 mg/cm² to about 100 mg/cm².

The selectively permeable coating may further include a polymer component, so that when applied and cured, if necessary, to the membrane, it forms an interpenetrating network or a cross-linked polymeric structure that may mechanically bind the coating to the membrane by interlinking with the pores of the membrane. In such embodiments, the selectively permeable coating may be mechanically secured to the membrane by an irreversible cross-linking or polymerization process. In other embodiments, the antimicrobial agent, or other component of the selectively permeable coating, may have a chemical affinity for the membrane, or a functional group capable of interacting with the membrane to enable the selectively permeable coating to be adhered to the membrane thereby.

In one embodiment, the selectively permeable coating may include an amine or imine containing polymer, such as, e.g., a hydroxyalkyl-substituted polyalkyleneimine or a polyvinyl alcohol-coamine. Advantageously, the hydroxyalkyl-substituted polyalkyleneimine may act as a polymeric component, as well as a chembio agent. In such embodiments, the hydroxyalkyl-substituted polyalkyleneneimine may include a structural unit having a formula (I):

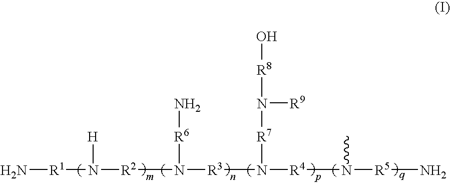

wherein “m” is an integer from 1 to 100, “n” is an integer from 0 to 100, “p” is an integer from 1 to 100, “q” is an integer from 0 to 100;
R¹, R², R³, R⁴, R⁵, R⁶, R⁷, and R⁸ are independently at each occurrence an aliphatic radical; and
R⁹ is hydrogen, an aliphatic radical, or a group having a formula (II)

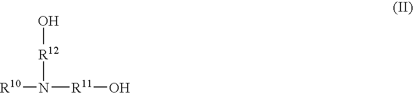

wherein R¹⁰, R¹¹, and R¹² are independently at each occurrence an aliphatic radical. Aliphatic radical is as defined hereinbelow:

Aliphatic radical is an organic radical having at least one carbon atom, a valence of at least one and may be a linear or branched array of atoms. Aliphatic radicals may include heteroatoms such as nitrogen, sulfur, silicon, selenium and oxygen or may be composed exclusively of carbon and hydrogen. Aliphatic radical may include a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example, carboxylic acid derivatives such as esters and amides), amine groups, nitro groups and the like. For example, the 4-methylpent-1-yl radical is a C₆ aliphatic radical comprising a methyl group, the methyl group being a functional group, which is an alkyl group. Similarly, the 4-nitrobut-1-yl group is a C₄ aliphatic radical comprising a nitro group, the nitro group being a functional group. An aliphatic radical may be a haloalkyl group that includes one or more halogen atoms, which may be the same or different. Halogen atoms include, for example; fluorine, chlorine, bromine, and iodine. Aliphatic radicals having one or more halogen atoms include the alkyl halides: trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (—CONH₂), carbonyl, dicyanoisopropylidene —CH₂C(CN)₂CH₂—), methyl (—CH₃), methylene (—CH₂—), ethyl, ethylene, formyl (—CHO), hexyl, hexamethylene, hydroxymethyl (—CH₂OH), mercaptomethyl (—CH₂SH), methylthio (—SCH₃), methylthiomethyl (—CH₂SCH₃), methoxy, methoxycarbonyl (CH₃OCO—), nitromethyl (—CH₂NO₂), thiocarbonyl, trimethylsilyl ((CH₃)₃Si—), t-butyldimethylsilyl, trimethoxysilylpropyl ((CH₃O)₃SiCH₂CH₂CH₂—), vinyl, vinylidene, and the like. By way of further example, a “C₁-C₃₀ aliphatic radical” contains at least one but no more than 30 carbon atoms. A methyl group (CH₃—) is an example of a C₁ aliphatic radical. A decyl group (CH₃(CH₂)₉—) is an example of a C₁₀ aliphatic radical.

In one embodiment, at least one of R¹, R², R³, R⁴, R⁵, R⁶, R⁷, and R⁸ may include an ethyl radical. In one embodiment, R¹, R², R³, R⁴, R⁵, R⁷, and R⁸ may include an ethyl radical. In one embodiment, the hydroxyalkyl-substituted polyalkyleneneimine may include hydroxyethyl-substituted polyethyleneneimine.

A polyalkyleneimine may be characterized by the hydroxyl count. In one embodiment, the average hydroxyl count per repeat unit of the hydroxyalkyl-substituted polyalkyleneneimine may be in a range of from about 0.5 to about 3. In one embodiment, the average hydroxyl count per repeat unit of the hydroxyalkyl-substituted polyalkyleneneimine may be in a range of from about 1 to about 3. In one embodiment, the average hydroxyl count per repeat unit of the hydroxyalkyl-substituted polyalkyleneneimine may be in a range that is greater than 3

A polyalkyleneimine may be characterized by a weight-average molecular weight. In one embodiment, the hydroxyalkyl-substituted polyalkyleneneimine may have a weight-average molecular weight in a range that is greater than about 1000 grams per mole. In one embodiment, the hydroxyalkyl-substituted polyalkyleneneimine may have a weight-average molecular weight in a range of from about 1000 grams per mole to about 2000 grams per mole, from about 2000 grams per mole to about 4000 grams per mole, from about 4000 grams per mole to about 8000 grams per mole, from about 8000 grams per mole to about 10000 grams per mole, or from about 10000 grams per mole to about 25000 grams per mole. In one embodiment, the hydroxyalkyl-substituted polyalkyleneneimine may have a weight-average molecular weight in a range of from about 25000 grams per mole to about 50000 grams per mole, from about 50000 grams per mole to about 75000 grams per mole, from about 75000 grams per mole to about 100000 grams per mole, from about 100000 grams per mole to about 200000 grams per mole, or from about 200000 grams per mole to about 250000 grams per mole.

In embodiments wherein the hydroxyalkyl-substituted polyalkyleneneimine desirably exhibits activity against chembio agents, it may be present in an effective amount. An effective amount of hydroxyalkyl-substituted polyalkyleneneimine refers to amount of hydroxyalkyl-substituted polyalkyleneneimine required to provide the functional groups sufficient to meet the performance requirements of the end-use application. In one embodiment, hydroxyalkyl-substituted polyalkyleneneimine may be present in an amount that is less than about 0.1 weight percent of the combined weight of the membrane and the selectively permeable coating. In one embodiment, the hydroxyalkyl-substituted polyalkyleneneimine may be present in a range of from about 0.1 weight percent to about 1 weight percent, from about 1 weight percent to about 2 weight percent, from about 2 weight percent to about 5 weight percent, from about 5 weight percent to about 10 weight percent of the combined weight of the membrane and the selectively permeable coating. In one embodiment, the hydroxyalkyl-substituted polyalkyleneneimine may be present in an amount in a range of from about 10 weight percent to about 20 weight percent, from about 20 weight percent to about 30 weight percent, from about 30 weight percent to about 40 weight percent, or from about 40 weight percent to about 50 weight percent of the combined weight of the membrane and the selectively permeable coating. In one embodiment, the hydroxyalkyl-substituted polyalkyleneneimine may be present in an amount that is greater than about 50 weight percent of the combined weight of the membrane and the selectively permeable coating. In one embodiment, the hydroxyalkyl-substituted polyalkyleneimine may be present is present in an amount in a range of from about 0.1 weight percent to about 20 weight percent of the combined weight of the membrane and the selectively permeable coating.

In one embodiment, the hydroxyalkyl-substituted polyalkyleneimine may be present in the article in an amount in a range of from about 0.5 mg/cm² to about 1 mg/cm², from about 1 mg/cm² to about 2 mg/cm², from about 2 mg/cm² to about 5 mg/cm², from about 5 mg/cm² to about 10 mg/cm², from about 10 mg/cm² to about 25 mg/cm², or from about 25 mg/cm² to about 50 mg/cm².

In other embodiments, the polymeric component may advantageously comprise a polyvinyl alcohol-coamine. Polyvinyl alcohol-coamine polymers are commercially available from, e.g., Celanese under the trade name Erkol®.

Any polymeric component included in the selectively permeable coating may include reactive groups capable of curing. A reactive group may participate in a chemical reaction when exposed to one or more of thermal energy, electromagnetic radiation, moisture curing, UV curing, or chemical reagents. Curing may refer to a reaction resulting in polymerization, cross-linking, or both polymerization and cross-linking of the selectively permeable coating.

In embodiments wherein the selectively permeable coating includes a polymeric component including reactive groups capable of curing, the selectively permeable coating may include a curing agent. The curing agent may catalyze (accelerate) a curing reaction of the polymeric component. In one embodiment, a curing agent may include one or more of epoxide, acid chloride, or chloroformate. In one embodiment, the curing agent may include a reactive triazine. A reactive triazine may include at least one reactive group capable of reacting with at least reactive group in the polymeric component of the selectively permeable coating. In one embodiment, a curing agent may be capable of initiating a chemical reaction between the polymeric component of the selectively permeable coating, if any, and the membrane.

In one embodiment, a reactive triazine may include a structural unit having a formula (III)

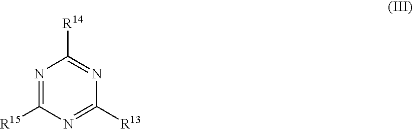

wherein R¹³, R¹⁴, and R¹⁵ includes at least reactive group capable of reacting with the hydroxyalkyl-substituted polyalkyleneimine. In one embodiment, the reactive triazine may include one or more carbamate functional groups. In one embodiment, the reactive triazine may include tris(alkoxycarbonylamino)triazine).

In one embodiment, the curing agent may be present in an amount in a range of from about 0.1 weight percent to about 2 weight percent of the selectively permeable coating, from about 2 weight percent to about 5 weight percent, from about 5 weight percent to about 10 weight percent, from about 10 weight percent to about 15 weight percent, from about 15 weight percent to about 20 weight percent, from about 20 weight percent to about 25 weight percent, or from about 25 weight percent to about 30 weight percent of the selectively permeable coating.

In one embodiment, the selectively permeable coating may be cured. Cured may refer to a selectively permeable coating comprising a polymeric component wherein more than about 5 percent of the reactive groups of the polymeric component have reacted, or alternatively a percent conversion that is in a range of greater than about 5 percent. Percent conversation may refer to a percentage of the total number of reacted groups to the total number of reactive groups. In one embodiment, the selectively permeable coating may be cured so that the selectively permeable coating may be chemically or mechanically bound to the membrane. The selectively permeable coating may be cured such that a substantial fraction hydroxyl groups remain substantially unaffected in the hydroxyalkyl-substituted polyalkyleneimine, in those embodiments of the invention wherein the same is utilized.

In embodiments of the invention comprising the hydroxyalkyl-substituted polyakyleneimine, the selectively permeable coating may further include a polyalkylamine. A polyalkylamine refers to a polymer including a plurality of amine groups and an alkyl-based polymer backbone. A suitable polyalkylamine may be a homopolymer, a copolymer, or derivatives thereof. Suitable derivatives may include one or more secondary amine groups, rather than a primary amine. In one embodiment, a polyalkylamine may provide additional functional properties to the selectively permeable coating, for example, MVTR, air permeability, chemical or microbial agent sorption, and the like.

In such embodiments, the polyalkylamine may be present in an amount in a range of from about 0.5 weight percent to about 1 weight percent, from about 1 weight percent to about 2 weight percent, from about 2 weight percent to about 5 weight percent, from about 5 weight percent to about 10 weight percent, from about 10 weight percent to about 20 weight percent, from about 20 weight percent to about 30 weight percent, from about 30 weight percent to about 40 weight percent, or from about 40 weight percent to about 50 weight percent of the selectively permeable membrane.

In one embodiment, the selectively permeable coating may include a hydroxyalkyl-substituted polyalkyleneimine and a polyvinylamine. A polyvinyl amine may refer to a polymer derived from a vinyl amine-based polymer precursor. In one embodiment, the selectively permeable coating may include a polyvinyl alcohol-vinyl amine copolymer and a hydroxyalkyl-substituted polyalkyleneimine. Suitable polyvinyl amine and derivatives thereof may be obtained commercially from BASF Corporation (Mount Olive, N.J.).

In such embodiments, the polyvinylamine may be present in an amount in a range of from about 0.5 weight percent to about 1 weight percent, from about 1 weight percent to about 2 weight percent, from about 2 weight percent to about 5 weight percent, from about 5 weight percent to about 10 weight percent, from about 10 weight percent to about 20 weight percent, from about 20 weight percent to about 30 weight percent, from about 30 weight percent to about 40 weight percent, or from about 40 weight percent to about 50 weight percent of the selectively permeable membrane.

In one embodiment, a curing agent for the polyalkyleneimine may also cure the polyalkylamine and/or polyvinylamine. In an alternate embodiment, a selectively permeable coating may include a curing agent different from a reactive triazine that is capable of initiating a curing reaction of the polyalkylamine and/or polyvinylamine. In one embodiment, the cured selectively permeable coating may include a cured reaction product of the polyalkyleneimine and the polyalkylamine and/or polyvinylamine.

A selectively permeable coating may be present on the surface of the membrane, inside the pores, or both on the surface of the membrane and inside the pores. In one embodiment, a selectively permeable coating may substantially coat an inner surface of the pores. In one embodiment, the coating may surround and adhere to the nodes and fibrils that define the pores in the membrane. In one embodiment, the coating may also conform to the surfaces of the nodes and fibrils that define the pore in the membrane. In such embodiments, the selectively permeable coating may essentially have a thickness of about zero, i.e., the selectively permeable coating may coat the inner surfaces of the pores of the membrane only.

In other embodiments, the coating may be deposited onto the membrane without blocking the pores of the membrane. Or, the coating may be without voids and/or “pin holes” to form a continuous coating. In yet other embodiments, the coating may have discontinuous portions. The coating layer may be uniform in thickness, or may have a thickness that differs from area to area.

In one embodiment, the selectively permeable coating may have a thickness in a range of from about 20 micrometers to about 40 micrometers, from about 40 micrometers to about 60 micrometers, from about 60 micrometers to about 120 micrometers, from about 120 micrometers to about 160 micrometers, from about 160 micrometers to about 200 micrometers, from about 200 micrometers to about 240 micrometers, from about 240 micrometers to about 280 micrometers, from about 280 micrometers to about 320 micrometers, from about 320 micrometers to about 360 micrometers, or from about 360 micrometers to about 400 micrometers. In one embodiment, the selectively permeable coating may have a thickness that is in a range of from about 400 micrometers to about 600 micrometers, from about 600 micrometers to about 800 micrometers, or from about 800 micrometers to about 1000 micrometers.

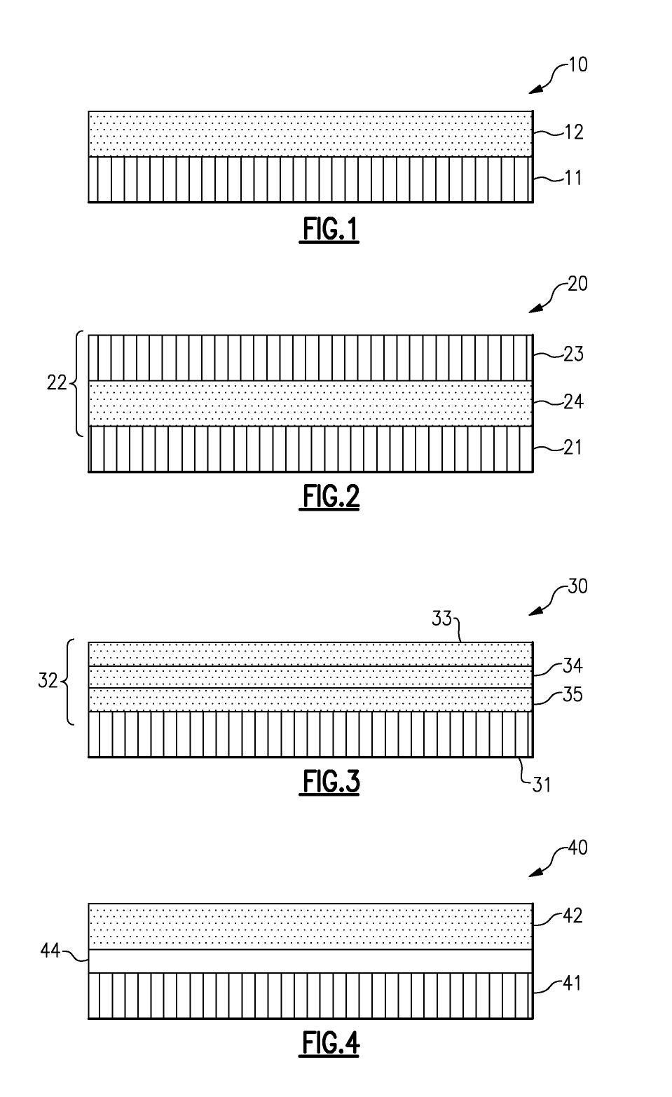

In one embodiment, the selectively permeable coating 12 may include a single layer supported on a membrane 11 to form an article 10 as shown in FIG. 1. The selectively permeable coating may have a thickness and/or weight in a range as described hereinabove. In an alternate embodiment, the selectively permeable coating may include two or more layers having a combined thickness and/or weight in a range as described hereinabove. At least one layer in the selectively permeable coating may include the antimicrobial agent.

In another embodiment, a selectively permeable coating 22 may include a plurality of layers wherein at least one layer may include at least one antimicrobial agent and at least one layer may include a non-functionalized ePTFE membrane 23 as shown in FIG. 2. The antimicrobial agent 24 may be sandwiched between the non-functionalized ePTFE membrane 23 and ePTFE membrane 21 to form an article 20. In one embodiment, a selectively permeable coating may include at least one sandwich structure wherein the layer having antimicrobial agent may be sandwiched between two ePTFE membranes and supported on a membrane to form an article. In one embodiment, a selectively permeable coating may include at least one layer having a chemical or microbial agent protective material different from the antimicrobial agent.

In one embodiment, a selectively permeable coating may include a plurality of thin layers instead of a single thick layer, wherein each layer in the plurality of layers may include the antimicrobial agent. FIG. 3 shows an article 30 with a selectively permeable coating 32 supported on a membrane 31, wherein the selectively permeable coating includes three layers 33, 34, and 35, each having at least one antimicrobial agent. In one embodiment, a selectively permeable coating may include a plurality of thin layers having the same thickness. In an alternate embodiment, a selectively permeable coating may include a plurality of thin layers having a range of thicknesses and/or weight depending on the end use application and the method employed for deposition of the selectively permeable coating on the membrane.

In one embodiment, an article may include one or more layers to provide functional properties in addition to the selectively permeable coating. In one embodiment, an article may include at least one hydrophilic coating supported on the membrane. The hydrophilic coating may be compatible with the material of the membrane and may impart hydrophilic properties to the membrane. Compatible means that the coating material may “wet-out” the surface of the membrane.

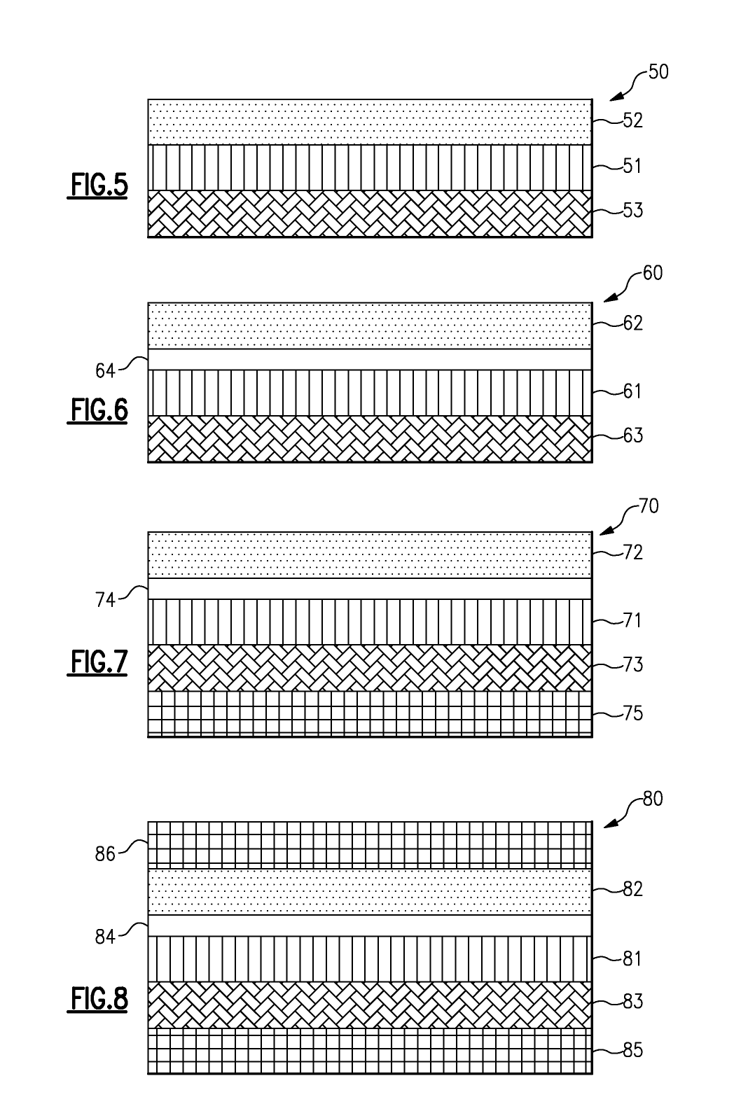

In one embodiment, a hydrophilic coating 44 maybe disposed between the membrane 41 and the selectively permeable coating 42 to form an article 40 as shown in FIG. 4. In an alternate embodiment, the hydrophilic coating is at least partially disposed between a surface of the membrane and the selectively permeable coating. As described hereinabove, a selectively permeable coating may include one layer or a plurality of layers, wherein at least one layer in the plurality may include the antimicrobial agent.

In embodiment, a hydrophilic coating may include a polyvinyl nucleophilic polymer and one or both of a blocked isocyanate or a urethane. A blocked isocyanate or a urethane may function as a curing agent for the polyvinyl nucleophilic polymer. In one embodiment, the polyvinyl nucleophilic polymer may include one or both of polyvinyl alcohol or polyvinyl amine. In one embodiment, the polyvinyl nucleophilic polymer may essentially include polyvinyl amine.

Suitable polyvinyl nucleophilic polymers may include those polyvinyl nucleophilic polymers having a molecular weight in a predetermined range of monomeric units. In one embodiment, the polyvinyl nucleophilic polymer molecular weight may be less than 2500. In one embodiment, the polyvinyl nucleophilic polymer molecular weight may be greater than 2500. In one embodiment, the polyvinyl nucleophilic polymer molecular weight may be in a range of from about 2500 to about 31,000, from about 31,000 to about 50,000, from about 50,000 to about 100,000, from about 100,000 to about 200,000 or greater than about 200,000.

Suitable blocked isocyanates may include a blocking agent, and one or more of aromatic polyisocyanates, aliphatic polyisocyanates, or cycloaliphatic polyisocyanates. In one embodiment, the polyisocyanates may include one or more of toluene diisocyanate, diphenyl methane diisocyanate, hexamethylene diisocyanate, methylene bis-(4-cyclohexylisocyanate), naphthalene di-isocyanate, polymethylene polyphenyl isocyanate, meta-tetramethylxylene diisocyanate, or dimethyl meta-isopropenyl benzyl isocyanate.

Suitable blocked isocyanates may be commercially available, or may be formed from, for example, a reaction of an isocyanate with a blocking agent, such as malonic ester. Other suitable blocking agents may include one or more amines, such as diisopropyl amine (DIPA) or t-butyl benzyl amine (BEBA). Yet other suitable blocking agents may include one or more of 3,5-dimethylpyrazole; methyl ethyl ketoxime; caprolactam; or alkylated phenol.

Some blocking agents may unblock in response to the application of heat. For example, 3,5-dimethylpyrazole may unblock at 110° C.; methyl ethyl ketoxime may unblock at 150° C.; malonic acid esters may unblock at 90° C.; caprolactam may unblock at 160° C.; and alkylated phenol may unblock at greater than about 110° C. Optional accelerators, when present, may decrease the unblocking temperature to as low as about room temperature.

In one embodiment, the blocked isocyanate may include hexamethylene di-isocyanate or methylene bis-(4-cyclohexyl isocyanate). In one embodiment, the blocked isocyanate may comprise a blocking agent and hexamethylene di-isocyanate. In one embodiment, the blocked isocyanate may comprise a blocking agent and methylene bis-(4-cyclohexyl isocyanate). Another suitable isocyanate may include a reactive triazine having at least one isocyanate functional group.

Suitable urethanes may include one or both of urethane materials or blocked isocyanates. In one embodiment, a urethane may include a triazine having at least one urethane functional group. Ammonium salts or amines (such as 4-dimethyl aminopyridine) may be used to accelerate urethane curing, which may be otherwise performed at, for example, about 100° C. to about 110° C. In one embodiment, about 0.5 weight percent of dodecyl benzene sulfonic acid may be added to improve hydrolytic stability and/or hardness.

Suitable amounts of blocked isocyanate or urethane may be greater than about 1 weight percent of the hydrophilic coating. In one embodiment, the amount of blocked isocyanate or urethane present may be in a range of from about 1 weight percent to about 5 weight percent, from about 5 weight percent to about 10 weight percent, from about 10 weight percent to about 15 weight percent, from about 15 weight percent to about 20 weight percent, from about 20 weight percent to about 25 weight percent, from about 25 weight percent to about 30 weight percent, from about 30 weight percent to about 40 weight percent, from about 40 weight percent to about 50 weight percent, from about 50 weight percent to about 60 weight percent, from about 60 weight percent to about 75 weight percent, or greater than about 75 weight percent based on the total weight of the hydrophilic coating.

In one embodiment, the antimicrobial agent may be capable of reacting or interacting with a microbial agent to inactivate the microbial agent. As used herein, the term “inactivating a microbial agent” may include one or both of reducing the biological activity of the microbial agent or increasing an amount of time for a significant amount of unreacted biologically active microbial agent to pass through the article. As used herein, the term “inactivating a microbial agent” may include reacting with the microbial agent to form a modified microbial agent that may have a biological activity that is less than that of the biological activity of the unreacted microbial agent. In one embodiment, the modified microbial agent may have biological activity that is at least 80 percent less than that of the biological activity of the unreacted chemical or microbial agent.

In those embodiments where the same is desirably included, the hydroxyalkyl-substituted polyalkyleneimine may be capable of reacting or interacting with a chembio agent to inactivate the chembio agent. As used herein, the term “inactivating a chembio agent” may include one or both of reducing the biological activity of the chembio agent or increasing an amount of time for a significant amount of unreacted biologically active chembio agent to pass through the article. As used herein, the term “inactivating a chembio agent” may include reacting the chembio agent to form a modified chembio agent that may have a biological activity that is less than that of the biological activity of the unreacted chembio agent. In one embodiment, the modified chembio agent may have a biological activity that is at least 80 percent less than that of the biological activity of the unreacted chembio agent.

In one embodiment, the hydroxyalkyl-substituted polyalkyleneimine may be capable of chemically reacting with a chembio agent to inactivate the chembio agent. In one embodiment, the hydroxyl groups in the polyalkyleneimine may be capable of chemically reacting with a chembio agent to inactivate the chembio agent. A chemical reaction may include for example a hydrolysis reaction or a nucleophilic substitution reaction.

As used herein, the term “chembio agent” includes a chemical agent, a biological agent, a microbial agent, or combinations of one or more chemical agent(s), biological agent(s) and/or microbial agents. A chemical agent may be a non-living chemical substance having toxic properties. A chemical agent may include nonliving toxic products produced by living organisms e.g., toxins. A biological agent may be a living or a quasi-living material (e.g., prions) having toxic properties. A microbial agent includes microorganisms, and in particular, pathogenic microorganisms. The major classes of microorganisms include bacteria, fungi such as mold mildew, yeasts and algae.

In one embodiment, a chembio agent may include a chemical warfare agent. Suitable chemical warfare agents may include one or more incapacitating agents, lachrymators, vesicants or blister agents, nerve agents, pulmonary agents, blood agents, or malodorants.

Suitable incapacitating agents may include nervous system affecters, vomiting agents, choking agents, hallucinogens, sedatives, narcotics, depressants, and the like, and combinations of two or more thereof. In one embodiment, an incapacitating agent may include 3-quinuclidinyl benzilate (QNB, BZ), which may be an anticholinergic agent that may react with a probe comprising, for example, choline. Alternative nervous system affecters may include commercially available, over-the-counter (OTC) or prescription pharmaceutical compositions. In one embodiment, an incapacitating agent may include curare, or a curare analog or derivative.

Suitable lachrymators may include one or more of o-chlorobenzylmalonitrile, chloromethyl chloroformate, stannic chloride, sym-dichloromethyl ether, benzyl bromide, xylyl bromide, methyl chlorosulphonate, ethyl iodoacetate, bromacetone, bromomethyl-ethyl ketone, acrolein (2-propenal), capsaicin, analogs and/or derivatives of these, or the like.

A suitable vesicant may include one or more of sulfur mustard, nitrogen mustard, or an arsenical such as Lewisite. Suitable sulfur mustard may include one or more of 2-chloroethyl chloromethyl sulfide, bis(2-chloroethyl) sulfide or dichloroethyl disulfide, bis(2-chloroethylthio) methane, 1,2-bis(2-chloroethylthio) ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, or bis(2-chloroethyl thioethyl)ether. Suitable nitrogen mustard may include one or more of bis(2-chloroethyl)ethylamine, bis(2-chloroethyl)methylamine, or tris (2-chloroethyl) amine. Suitable Lewisites may include one or more of 2-chlorovinyl dichloroarsine, or bis(2-chlorovinyl) chloroarsine, tris (2-chlorovinyl) arsine.

Suitable nerve agents may include cholinesterase inhibitors. In one embodiment, a cholinesterase inhibitor may include one or more of o-alkyl (Me, Et, n-Pr or i-Pr)-phosphonofluoridates, such as o-isopropyl methylphosphonofluoridate (sarin) or o-pinacolyl methylphosphonofluoridate (soman); o-alkyl N,N-dialkyl (Me, Et, n-Pr or i-Pr) phosphoramidocyanidates, such as o-ethyl N,N-dimethyl phosphoramidocyanidate (tabun); or o-alkyl S-2-dialkyl (Me, Et, n-Pr or i-Pr)-aminoethyl alkyl (Me, Et, n-Pr or i-Pr) phosphonothiolates and corresponding alkylated or protonated salts, such as o-ethyl S-2-diisopropylaminoethyl methyl phosphonothiolate.

Suitable pulmonary agents may include one or both of phosgene (carbonyl chloride) and perfluororoisobutylene. Suitable chemical toxins may include one or more of palytoxin, ricin, saxitoxin, or botulinum toxin.

Suitable blood agents may include forms of cyanide such as salts, and analogs and derivatives of cyanide salts. A suitable solid salt of cyanide may include sodium, potassium, and/or calcium. A suitable volatile liquid form of cyanide may include hydrogen cyanide and/or cyanogen chloride.

In one embodiment, a chembio agent may include one or more toxic industrial chemical (TIC). In one embodiment, a chemical or microbial agent may include one or more toxic industrial materials (TIM). Toxic industrial materials may include one or more of ammonia, arsine, boron trichloride, boron trifluoride, carbon disulfide, chlorine, diborane, ethylene oxide, formaldehyde, phosgene, phosphorus trichloride, sulfur dioxide, sulfuric acid, cyanogen chloride, hydrogen bromide, hydrogen chloride, hydrogen fluoride, hydrogen sulfide, or hydrogen cyanide.

In one embodiment, a chembio agent may include one or more biological agents. Suitable biological agents may include pathogens. Pathogens are infectious agents that may cause disease or illness to their host (animal or plant). Biological agents may include prions, microorganisms (viruses, bacteria and fungi) and some unicellular and multicellular eukaryotes (for example parasites) and their associated toxins. In some embodiments, pathogens may include one or more of bacteria, protozoa, fungus, parasites, or spore. In some embodiments, pathogens may include virus or prion.

Some examples of bacterial biological agents (and the diseases or effect caused by them) may include one or more of: escherichia coli (peritonitis, food poisoning); mycobacterium tuberculosis (tuberculosis); bacillus anthracis (anthrax); salmonella (food poisoning); staphylococcus aureus (toxic shock syndrome); streptococcus pneumoniae (pneumonia); streptococcus pyogenes (strep throat); helicobacter pylori (stomach ulcers); or francisella tularensis (tularemia).

Some examples of viruses (and the diseases or effect caused by them) may include one or more of hepatitis A, B, C, D and E (liver disease); influenza virus (flu, Avian flu); SARS coronavirus (severe acute respiratory syndrome); herpes simplex virus (herpes); molluscum contagiosum (rash); or human immunodeficiency virus (AIDS).

Some examples of protozoa (and the diseases or effect caused by them) may include one or more of cryptosporidium (cryptosporidiosis); giardia lamblia (giardiasis); plasmodium (malaria); or trypanosoma cruzi (chagas disease). Some examples of fungi (and the diseases or effect caused by them) may include one or more of pneumocystis jiroveci (opportunistic pneumonia); tinea (ringworm); or candida (candidiasis).

Some examples of parasites may include one or more of roundworm, scabies, tapeworm, or flatworm. Some examples of protein-based pathogens may include prions (Bovine spongiform encephalopathy (BSE) commonly known as mad cow disease or variant Creutzfeldt-Jakob disease (vCJD)).

Toxins include proteins capable of causing disease on contact or absorption with body tissues by interacting with biological macromolecules and may be used as bioweapons. Suitable toxins may include Ricin, SEB, Botulism toxin, Saxitoxin, and many Mycotoxins.

Some other examples of diseases caused by biological agents may include anthrax, Ebola, Bubonic Plague, Cholera, Tularemia, Brucellosis, Q fever, Machupo, Coccidioides mycosis, Glanders, Melioidosis, Shigella, Rocky Mountain Spotted Fever, Typhus, Psittacosis, Yellow Fever, Japanese B Encephalitis, Rift Valley Fever, or Smallpox.

An article as described herein may be characterized by a combination of comfort and protective barrier properties. Comfort and protective barrier properties may be characterized by one or more of thickness, unit average weight, air permeability, moisture vapor transmission rate (MVTR), or chemical or microbial agent permeability of the article. In one embodiment, the article may have a thickness in a range of from about 300 micrometers to about 400 micrometers, from about 400 micrometers to about 500 micrometers, from about 500 micrometers to about 600 micrometers, from about 600 micrometers to about 700 micrometers, from about 700 micrometers to about 800 micrometers, from about 800 micrometers to about 900 micrometers, from about 900 micrometers to about 1000 micrometers, from about 1000 micrometers to about 10000 micrometers.

In one embodiment, the article may have a unit average weight in a range of from about 5 mg/cm² to about 30 mg/cm², from about 30 mg/cm² to about 40 mg/cm², from about 40 mg/cm² to about 50 mg/cm², from about 50 mg/cm² to about 60 mg/cm², from about 60 mg/cm² to about 70 mg/cm², from about 70 mg/cm² to about 80 mg/cm², from about 80 mg/cm² to about 90 mg/cm², from about 90 mg/cm² to about 200 mg/cm².

In one embodiment, the membrane may have air permeability that is less than about 6 cfm at 0.5 inches H₂O. In one embodiment, the membrane may have air permeability that is in a range of from about 0.01 cfm to about 0.1 cfm, from about 0.1 cfm to about 0.5 cfm, from about 0.5 cfm to about 1 cfm, from about 1 cfm to about 2 cfm, from about 2 cfm to about 3 cfm, from about 3 cfm to about 4 cfm, from about 4 cfm to about 5 cfm, or from about 5 cfm to about 6 cfm. Air permeability as described herein maybe measured using the test conditions described herein in the specification. As used herein, cfm/ft is cubic feet per minute.

In one embodiment, the article may have a moisture vapor transmission rate (MVTR) that is greater than about 500 g/m²/day. In one embodiment, the article may have a moisture vapor transmission rate in a range of from about 500 g/m²/day to about 600 g/m²/day, from about 600 g/m²/day to about 800 g/m²/day, from about 800 g/m²/day to about 1000 g/m²/day, from about 1000 g/m²/day to about 1500 g/m²/day, or from about 1500 g/m²/day to about 2000 g/m²/day. In one embodiment, the article may have a moisture vapor transmission rate (MVTR) that is greater than about 2000 g/m²/day.

In one embodiment, the article may have a moisture vapor transmission rate (MVTR) that is greater than about 4000 g/m²/day. In one embodiment, the article may have a moisture vapor transmission rate in a range of from about 4000 g/m²/day to about 5000 g/m²/day, from about 5000 g/m²/day to about 6000 g/m²/day, from about 6000 g/m²/day to about 7000 g/m²/day, from about 7000 g/m²/day to about 8000 g/m²/day, or from about 8000 g/m²/day to about 10000 g/m²/day. In one embodiment, the article may have a moisture vapor transmission rate in a range of from about 10000 g/m²/day to about 15000 g/m²/day, from about 15000 g/m²/day to about 20000 g/m²/day, from about 20000 g/m²/day to about 25000 g/m²/day, from about 25000 g/m²/day to about 30000 g/m²/day, or from about 30000 g/m²/day to about 40000 g/m²/day. In one embodiment, the article may have a moisture vapor transmission rate (MVTR) that is greater than about 40000 g/m²/day.

In one embodiment, the article may have permeability to DFP (simulate for sarin) that is less than about 50 micrograms/24 hours. In one embodiment, the article may have a permeability to DFP (simulate for sarin) in a range of from about 1 microgram/24 hours to about 5 micrograms/24 hours, from about 5 microgram/24 hours to about 10 micrograms/24 hours, from about 10 microgram/24 hours to about 20 micrograms/24 hours, from about 20 microgram/24 hours to about 30 micrograms/24 hours, or from about 30 microgram/24 hours to about 40 micrograms/24 hours, or from about 40 microgram/24 hours to about 50 micrograms/24 hours. In one embodiment, the article may have permeability to a DFP (simulate for sarin) that is less than about 1 microgram/24 hours. In one embodiment, the article may have permeability to a chemical or microbial agent that is less than that toxicity level for a particular chemical or microbial agent.

The performance characteristics of a selectively permeable coating may also be characterized by one or more of the chemical or microbial agent deactivation rate. In one embodiment, the selectively permeable coating may show a deactivation rate for a chemical or microbial agent in a range of about 2 g/hr/m². In one embodiment, the selectively permeable coating may show a deactivation rate for a chemical or microbial agent in a range from about 2 g/hr/m² to about 3 g/hr/m², from about 3 g/hr/m² to about 4 g/hr/m², or from about 4 g/hr/m² to about 5 g/hr/m². In one embodiment, the selectively permeable coating may show a deactivation rate for a chemical or microbial agent in a range that is greater about 5 g/hr/m².

In one embodiment, at a dosing level of 10 g/m², the selectively permeable coating may exhibit greater than about 5 percent deactivation after a 24-hour period. In one embodiment, at a dosing level of 10 g/m², the selectively permeable coating may exhibit percentage deactivation in a range of from about 5 percent to about 10 percent, from about 10 percent to about 20 percent, from about 20 percent to about 30 percent, from about 30 percent to about 40 percent, from about 40 percent to about 50 percent, from about 50 percent to about 60 percent, from about 60 percent to about 70 percent, from about 70 percent to about 80 percent, from about 80 percent to about 90 percent, or from about 90 percent to about 95 percent after a 24 hour period. In one embodiment, at a dosing level of 10 g/m², the selectively permeable coating may exhibit about 100 percent deactivation after a 24-hour period.

In one embodiment, the selectively permeable coating may exhibit a breach time to an unreacted chemical or microbial agent in a range that is greater than about 30 minutes. In one embodiment, the selectively permeable coating may exhibit a breach time to an unreacted chemical or microbial agent in a range of from about 30 minutes to about 1 hour, from about 1 hour to about 2 hours, from about 2 hours to about 3 hours, from about 3 hours to about 4 hours, from about 4 hours to about 6 hours, from about 6 hours to about 7 hours, from about 7 hours to about 8 hours, from about 8 hours to about 9 hours, or from about 9 hours to about 10 hours. In one embodiment, the selectively permeable coating may exhibit a breach time to an unreacted chemical or microbial agent in a range that is greater than about 10 hours.

In one embodiment, a laminate is provided. The laminate includes an article as described hereinabove and an oleophobic membrane. The article may be supported on the oleophobic membrane. In one embodiment, the oleophobic membrane may refer to a membrane that is resistant to contamination by absorbing or adsorbing oils, greases or body fluids, such as perspiration and certain other contaminating agents. In one embodiment, the oleophobic membrane may be gas permeable, liquid penetration resistant and capable of moisture vapor transmission at a rate of at least 70,000 g/m²/day.

In one embodiment, an oleophobic membrane may include a plurality of interconnecting pores extending through the membrane and made from a material that tends to absorb oils and certain contaminating surfactants, for example ePTFE. A coating may be disposed on surfaces of the nodes and fibrils defining the interconnecting passages in the membrane. The coating may include oleophobic fluoropolymer solids coalesced on surfaces of the nodes and fibrils to provide oil and surfactant resistance to the resultant oleophobic membrane without completely blocking pores in the membrane.

Suitable oleophobic fluoropolymer solids may include an acrylic-based polymer with fluorocarbon side chains and a relatively small amount of water, water-soluble co-solvent and glycol. In one embodiment, suitable oleophobic fluoropolymer solids may include Zonyl family of fluorine containing polymers (available from CIBA Specialty Chemicals). In an alternative embodiment, suitable oleophobic fluoropolymer solids may include fluoropolymers commercially available under the trade name of TLF-8868, TLF-9312, TLF-9373, TLF-9404A and TLF-9494B (available from DuPont).

In one embodiment, the oleophobic membrane may be formed by wetting the surface of the pores with a diluted and stabilized dispersion of oleophobic fluoropolymer solids. The oleophobic fluoropolymer solids of the dispersion may be then coalesced on surfaces that define pores in the membrane. In one embodiment, the oleophobic membrane may be commercially available under the trade name of eVENT (from BHA Technologies, MO).

In one embodiment, the selectively permeable coating 52 may be supported on a membrane 51 to form a selectively permeable membrane, which may be supported on an oleophobic membrane 53 as shown in FIG. 5 to form a laminate 50. A selectively permeable coating may include only one layer or may include a plurality of layers wherein at least one layer in the plurality may include the hydroxyalkyl-substituted polyethyleneimine. As described earlier, a laminate may include one or more additional layer, for example, a hydrophilic coating. Although FIG. 5 shows only one selectively permeable membrane, multiple layers of selectively permeable membranes may be possible in the laminate structure 50. Here and throughout the specification and claims, the various representations of the laminate structure are merely representative and do not show all the possible embodiments of the inventions.

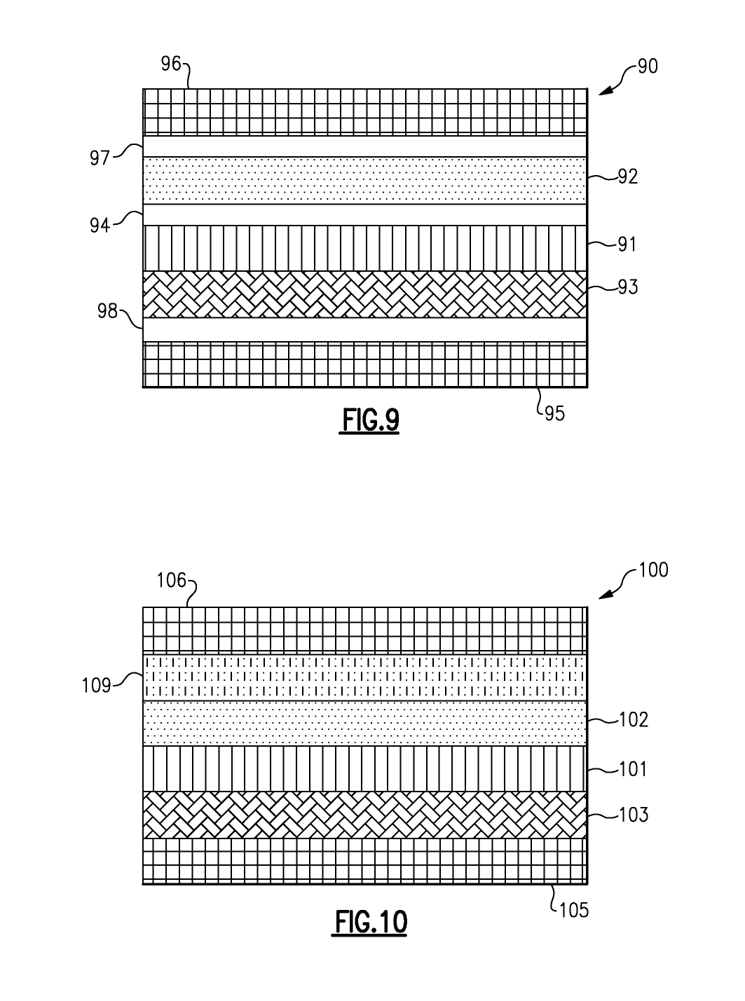

FIG. 6 shows a laminate 60 containing a selectively permeable coating 62 supported on a hydrophilic coating 64. The hydrophilic coating 64 is supported on a membrane 61, which is supported on an oleophobic membrane 63. A selectively permeable coating may include only one layer or may include a plurality of layers wherein at least one layer in the plurality may include the antimicrobial agent. Although FIG. 6 shows only one selectively permeable membrane, multiple layers of selectively permeable membranes may be possible in the laminate structure 60.

In one embodiment, a laminate may include a shell layer selected from one or more of a fabric, a membrane, or a film. In one embodiment, the oleophobic membrane may have a first surface and a second surface, and the article may be supported on a first surface of the oleophobic membrane and the shell layer may be supported on a second surface of the oleophobic membrane. FIG. 7 shows a laminate 70 containing a selectively permeable coating 72 supported on a membrane 71, which is supported on a first surface of an oleophobic membrane 73. A shell layer 75 is supported on the second surface of the oleophobic membrane 73. In some embodiments, an additional hydrophilic coating 74 (optional) may be disposed between the selectively permeable coating 72 and the membrane 71. Although FIG. 7 shows only one selectively permeable coating, multiple layers of selectively permeable coatings may be possible in the laminate structure 70.

In one embodiment, a shell layer may include one or more fabric layers. In one embodiment, a fabric layer may be sufficiently flexible, pliable and durable for use in articles of apparel or enclosures such as garments, tents, sleeping bags, casualty bags, and the like.

In one embodiment, the one or more fabric layers may include a polymer selected from poly(aliphatic amide), poly(aromatic amide), polyester, polyolefin, wool, cellulose based fibers such as cotton, rayon, linen, cellulose acetate and other modified cellulose, polyurethane, acrylics, methacrylics, or a blend comprising any of the above. In one embodiment, the one or more fabric layers may include cotton, poly (aliphatic amide), poly (aromatic amide), polyester, polyurethanes, or blends thereof.

In some embodiments, the one or more fabric layers may be made of woven fabric. In alternate embodiments, the one or more fabric layers may be made of a non-woven fabric. A non-woven fabric may be knit, braided, tufted, or felted.

In one embodiment, a laminate may include an article as described herein, an oleophobic membrane, and at least two fabric materials. The two fabric layers may include the same fabric material or may include different fabric layers. In one embodiment, a laminate 80 may include an outer fabric layer 85 and an inner fabric layer 86 as shown in FIG. 8. The selectively permeable coating 82 is supported on the membrane 81, which is supported on the oleophobic membrane 83 and the resulting structure is sandwiched between the outer fabric layer 85 and the inner fabric layer 86. In some embodiments, an additional hydrophilic coating 84 (optional) may be disposed between the selectively permeable coating 82 and the membrane 81. As described hereinabove, a selectively permeable coating may include one layer or a plurality of layers, wherein at least one layer in the plurality may include an antimicrobial agent. Although FIG. 8 shows only one selectively permeable membrane, multiple layers of selectively permeable membranes may be possible in the laminate structure 80.

An outer fabric layer is the outermost layer of the laminate, which is exposed to the elements. In one embodiment, an outer fabric layer may be woven fabric made of poly(aliphatic amide), poly (aromatic amide), polyester, acrylic, cotton, wool and the like. In one embodiment, the outer fabric layer may be treated to render it hydrophobic or oleophobic. In one embodiment, an inner fabric may be a knit, woven or non-woven fabric, and may be treated to enhance moisture wicking properties or to impart hydrophobic or oleophobic properties.

In some embodiments, the fabric layers may be treated with suitable materials so as to impart properties such as flame resistance, anti static properties, ultra-violet radiation resistance, controlled infrared (I. R.) reflectance, camouflage, and the like.

In one embodiment, a laminate may include one or more additional layers, for example, one or more of a hydrophilic membrane layer, an oleophobic membrane layer, or a porous membrane layer. FIG. 9 shows a laminate 90 in accordance with one embodiment of the invention. The selectively permeable coating 92 is supported on the membrane 91, which is supported on the oleophobic membrane 93 and the resulting structure is sandwiched between the outer fabric layer 95 and the inner fabric layer 96.

A first additional layer 97 is present between the selectively permeable coating 92 and the inner fabric layer 96. The first additional layer 97 may be a hydrophilic membrane, an oleophobic membrane, or a microporous membrane. In an alternate embodiment, a second additional layer 98 may be present between the oleophobic membrane 93 and the outer fabric layer 95. The additional layer 98 may be a hydrophilic membrane, an oleophobic membrane, or a microporous membrane. In some embodiments, an additional hydrophilic coating 94 (optional) may be disposed between the selectively permeable coating 92 and the membrane 91. As described hereinabove, a selectively permeable coating may include one layer or a plurality of layers, wherein at least one layer in the plurality may include one or more antimicrobial agents. Although FIG. 9 shows only one selectively permeable membrane, multiple layers of selectively permeable membranes may be possible in the laminate structure 90.

In some embodiments, the laminate may be combined with other protective layers to achieve additional features. For example, a second selectively permeable layer may be inserted anywhere in the laminate as is shown in FIG. 10. The laminate 100 of FIG. 10 employs a first selectively permeable coating 102 and a second permeable coating 109. The first selectively permeable coating 102 is supported on the membrane 101, which is supported on the oleophobic membrane 103 and the resulting structure is sandwiched between the outer fabric layer 105 and the inner fabric layer 106. The second selectively permeable coating 109 is present between the selectively permeable coating 102 and the inner fabric layer 106. In some embodiments, the second selectively permeable coating 109 may include selectively permeable material different from the antimicrobial agent. As described hereinabove, a selectively permeable coating may include one layer or a plurality of layers, wherein at least one layer in the plurality may include at least one antimicrobial agent.

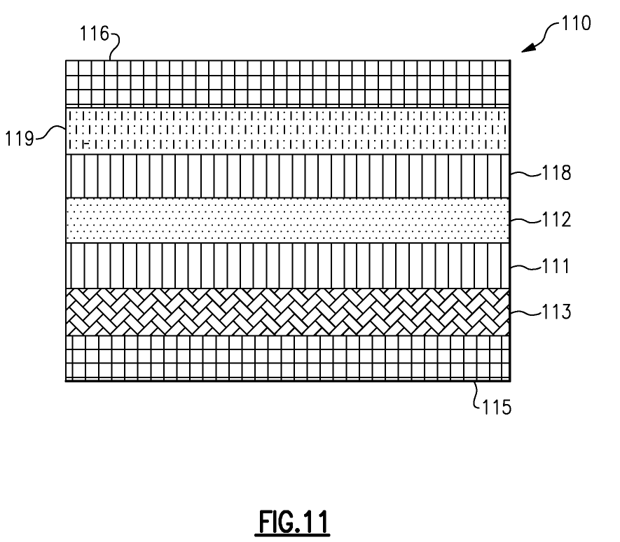

FIG. 11 shows a laminate 110 including at least two porous membranes. The laminate 110 of FIG. 11 employs a first selectively permeable coating 112 and a second selectively permeable coating 119. The first selectively permeable coating 112 is supported on the first porous membrane 111, which is supported on the oleophobic membrane 113. The second selectively permeable coating 119 is supported on the second porous membrane 118 and is present between the selectively permeable coating 112 and the inner fabric layer 116. The resulting structure is sandwiched between the outer fabric layer 115 and the inner fabric layer 116. In some embodiments, the second selectively permeable layer may include selectively permeable material different from the antimicrobial agent. As described hereinabove, a selectively permeable coating may include one layer or a plurality of layers, wherein at least one layer in the plurality may include at least one antimicrobial agent.

In one embodiment, at least one layer in the laminate may include one or more of an enzymatically-active material, catalytically active material, or a chemical-sorbing material. The enzymatically-active material, the catalytically active material, or a chemical-sorbing material may be present in any layer of the laminate structures. For example, the enzymatically-active material, the catalytically active material, or a chemical-sorbing material may be present in one or more of the selectively permeable coating, the hydrophilic membrane, the oleophobic membrane, the outer fabric layer, the inner fabric layer, or other suitable layers. In some embodiments, different layers in the laminate may include the enzymatically-active material, the catalytically active material, or a chemical-sorbing material independently. For example, an outer fabric layer may include an enzymatically-active material, an inner fabric layer may include a chemical-sorbing material, and a selectively permeable coating may include catalytically active particles.

In some embodiments, the selectively permeable coating may include one or more of the enzymatically-active material, the catalytically active material, or a chemical-sorbing material. In some embodiments, the outer fabric layer may include one or more of the enzymatically-active material, the catalytically active material, or a chemical-sorbing material. In some embodiments, the inner fabric layer may include one or more of the enzymatically-active material, the catalytically active material, or a chemical-sorbing material. In some embodiments, additional membrane layers may include one or more of the enzymatically-active material, the catalytically active material, or a chemical-sorbing material.

An enzymatically-active material may include enzymes capable of catalyzing a chemical reaction of a chemical or microbial agent. An enzymatically active material may include one or more of organophosphorous hydrolase, diisopropylfluorophosphatase, organophosphorous acid anhydrolase, phosphotriesterase, haloamine, or quaternary ammonium salt. In one embodiment, an enzymatically active material may include Lybradyn-OPH, BioCatalytics DFPase, or Genencor Defenz.

Catalytically active nanoparticles, as used herein, include particles with active species or particles capable of generating active species in response to a stimulus (for example, UV radiation). The active species may be capable of reacting or interacting with chemical or microbial agents to reduce their activity, to increase their infiltration time through the membrane, or convert them to a harmless by-product or end product. Nanoparticles as used herein refers to particles having an average particle size on the nano scale.

A nanoparticle may have a largest dimension (for example, a diameter or length) in the range of from about 1 nanometer to 1000 nanometers. Nanoparticle as used herein, may refer to a single nanoparticle, a plurality of nanoparticles, or a plurality of nanoparticles associated with each other. Associated refers to a metal nanoparticle in contact with at least one other metal nanoparticle. In one embodiment, associated refers to a metal nanoparticle in contact with more than one other particle.

A catalytically active material may include a plurality of nanoparticles selected from the group consisting of silver, copper, magnesium oxide, titanium oxide, and aluminum oxide. A chemical-sorbing material may include active carbon.

In one embodiment, the article may comprise chemical or microbial agent protective apparel. In one embodiment, the membrane may be supported on one or more fabric layers to form the chem bio agent protective apparel, as described hereinabove. In one embodiment, the chemical or microbial agent protective apparel may be capable of transmitting moisture vapor and may reduce the exposure of a person to harmful chemical or microbial agents. In one embodiment, the chemical or microbial agent protective apparel may reduce the exposure of a person to harmful chemical or microbial agents by reducing the biological activity of the chemical or microbial agent or increasing an amount of time for a significant amount of unreacted biologically active chemical or microbial agent to pass through the chemical or microbial agent protective apparel.

In one embodiment, chemical or microbial agent protective apparel may include garments such as outerwear. In one embodiment, the chemical or microbial agent protective apparel may include outerwear having an outward facing surface capable of abrasion resistance. Outerwear may include one or more of jackets, tops, shirts, pants, hoods, gloves, coveralls, and the like. In one embodiment, the chemical or microbial agent protective apparel may include footwear including, socks, shoes, boots, and the like.

In one embodiment, the chemical or microbial agent protective apparel may include innerwear or footwear capable of being worn against exposed skin. In one embodiment, a chemical or microbial agent may include innerwear capable of being worn in fluid communication with skin. In one embodiment, the chemical or microbial agent protective apparel may include a decontamination suit. In one embodiment, an article as described hereinabove may be employed in protective enclosures such as tents, sleeping bags, casualty bags, shelters and the like.

In one embodiment, a method is provided. A method includes application of a selectively permeable coating to a porous membrane. The selectively permeable coating includes an antimicrobial agent. The antimicrobial agent is present in an amount that is sufficient to chemically react with a chemical or microbial agent to reduce the biological activity of the chemical or microbial agent or increase an amount of time for a significant amount of unreacted biologically active chemical or microbial agent to pass through the article.

In one embodiment, the selectively permeable coating may be applied to the membrane by a coating technique, for example, dip-coating, slot-die coating, and the like. In one embodiment, the selectively permeable coating may be incorporated into the porous membrane by adding a solution of the antimicrobial agent to the membrane fabrication process. In embodiments involving a plurality of layers combined to form a selectively permeable coating, the different layers may be applied to the membrane in series or the selectively permeable coating may be prefabricated and then laminated to the membrane.

In some embodiments, the selectively permeable coating may be made to coat or cover a porous membrane, essentially residing on the surface using the methods disclosed herein. In alternate embodiments, the selectively permeably coating may additionally be made to imbibe into a membrane or membranes, through the membrane thickness, either to a very little extent or such an extent that the selectively permeable coating substantially coats the pores within a membrane through its entire thickness. In some embodiments, the selectively permeable coating may be made to reside completely within such membrane pores, or only a portion of the selectively permeable coating may be made to reside within the pores.

In one embodiment, a solution of the selectively permeable coating may be applied to the membrane. A suitable solvent may be aqueous or non-aqueous depending on the solubility of the antimicrobial agent in the particular solvent. Suitable solvents may include aliphatic hydrocarbons, aromatic hydrocarbons, compounds with hydrogen bond accepting ability, or solvents miscible with water. Suitable aliphatic and aromatic hydrocarbon compounds may include one or more of hexane, cyclohexane, and benzene, which may be substituted with one or more alkyl groups containing from 1-4 carbon atoms. Suitable compounds with hydrogen-bond accepting ability may include one or more of the following functional groups: hydroxyl groups, amino groups, ether groups, carbonyl groups, carboxylic ester groups, carboxylic amide groups, ureido groups, sulfoxide groups, sulfonyl groups, thioether groups, and nitrile groups. Suitable solvents may include one or more alcohols, amines, ethers, ketones, aldehydes, esters, amides, ureas, urethanes, sulfoxides, sulfones, sulfonamides, sulfate esters, thioethers, phosphines, phosphite esters, or phosphate esters. Some other examples of suitable non-aqueous solvents include toluene, hexane, acetone, methyl ethyl ketone, acetophenone, cyclohexanone, 4-hydroxy-4-methyl-2-pentanone, isopropanol, ethylene glycol, propylene glycol, diethylene glycol, benzyl alcohol, furfuryl alcohol, glycerol, cyclohexanol, pyridine, piperidine, morpholine, triethanolamine, triisopropanolamine, dibutylether, 2-methoxyethyl ether, 1,2-diethoxyethane, tetrahydrofuran, p-dioxane, anisole, ethyl acetate, ethylene glycol diacetate, butyl acetate, gamma-butyrolactone, ethyl benzoate, N-methylpyrrolidinone, N,N-dimethylacetamide, 1,1,3,3-tetramethylurea, thiophene, tetrahydrothiophene, dimethylsulfoxide, dimethylsulfone, methanesulfonamide, diethyl sulfate, triethylphosphite, triethylphosphate, 2,2′-thiodiethanol, acetonitrile, or benzonitrile. In one embodiment, a method may include removing any residual solvent from the membrane by air-drying, vacuum drying, heat drying, or combinations thereof.

In one embodiment, a method may include fabrication of a laminate that may be used for example as in a chemical or microbial agent protective article. In one embodiment a selectively permeable membrane may be laminated to one or more layer of a membrane, a film, or an apparel fabric. In one embodiment a selectively permeable membrane may be laminated to one or more layer of a hydrophilic membrane, an oleophobic membrane, an outer layer fabric, or an inner layer fabric. In one embodiment, lamination may be achieved by thermal bonding, hot roll lamination, ultrasonic lamination, adhesive lamination, forced hot air lamination, or by mechanical attachment such as stitches.

In one embodiment, a laminate may be fabricated using a seaming technique. A seaming technique may involve stitching or heat sealing the edges to be joined and then heat sealing the seam to the inside of the laminate. In one embodiment, the laminate may be fabricated using adhesives or stitching. Stitching if employed may be present throughout the layers such as in quilting, or point bonded non-woven materials, or may only be present at the seams or at the cuffs, for example in garments, gloves and other articles of clothing.

In one embodiment, a method may include contacting the article with a chemical or microbial agent. In one embodiment, a method for reducing exposure of a person to biologically active chemical or microbial agents is provided. The method may include exposing a chemical or microbial agent to a membrane having pores and a selectively permeable coating. The method may include infiltrating the chemical or microbial agent into the pores and reacting the chemical or microbial agent with the antimicrobial agent.

In one embodiment, the method may include one or both of reducing the biological activity of the chemical or microbial agent or increasing an amount of time for a significant amount of unreacted biologically active chemical or microbial agent to pass through the article. In one embodiment, a method may include reducing the biological activity of the chemical or microbial agent by at least 80 percent. In one embodiment, a method may include increasing an amount of time for a significant amount of unreacted biologically active chemical or microbial agent to pass through the article by 1 hour.

In one embodiment, a method may include interposing between a person and a chemical or microbial agent, chemical or microbial agent protective apparel including a membrane that has preferential permeability towards water vapor relative to the chemical or microbial agent.

### EXAMPLES

The following examples are intended only to illustrate methods and embodiments in accordance with the invention, and as such should not be construed as imposing limitations upon the clauses.

### Test Methods

Moisture Vapor Transmission Rate (MVTR) is measured using the ASTM E99 method unless otherwise indicated. Air permeability is measured using the ASTM 737 method unless otherwise indicated. Chemical or microbial agent permeability is measured by US Army Test operating Protocol (TOP 8-2-501 method) or by the ASTM F739 method unless otherwise indicated. TOP 8-2-501 method is the method for permeation and penetration testing of air-permeable, semipermeable, and impermeable materials with chemical agents or simulants (swatch testing). It is published by the U.S. Army Dugway Proving Ground West Desert Test Center. Dugway, Utah. Unit average weight of the membrane is determined by the ASTM D3776 method unless otherwise indicated. IPA bubble point is determined by the ASTM M F 316 method unless otherwise indicated.

### Example 1

### Coating Antimicrobial Agent on PTFE Membrane

The antimicrobial agent BA-1 is obtained from HaloSource, Inc. Redmond Wash. e-PTFE membrane (grade QM012) having a mean pore size of around 0.2 microns average and 0.5 micron maximum is obtained from GE Energy, Kansas City.

5.0 grams of BA-1 and 95.0 grams isopropanol (IPA) are mixed to provide 100 grams of a 5% BA-1 (w/w) solution. A PTFE membrane is submerged in the 5% BA-a solution for 15 minutes, the solution covered with parafilm to prevent evaporation. The membrane is removed from the solution and transferred to a metal rack to evaporate the coating solution prior to curing. The membrane is presumed dry when it returns to its original, unwetted color. The membrane is transferred to an oven preheated to about 100° C. and cured for 60 minutes. The membrane is then removed from the oven and allowed to cool at room temperature. The membrane is then placed in 50 mL of IPA and stirred for one minute to remove any unbound BA-1. The membrane is then again air dried.

30 mL of Clorox regular bleach is mixed with 270 mL of tap water and the pH of the bleach solution adjusted to between 7.0 and 7.5 with citric acid. The sample is submerged into the bleach solution for 30 minutes, with stirring to ensure maximum contact between the sample and the bleach solution. The sample is then removed from the bleach solution and air dried, or may also be dried in an over at about 65° C. for 2 hours.

To determine the level of chlorine functionality imparted to the sample, a 0.50 gram sample is cut and placed in an Erlenmeyer flask. 35 mL of ethanol and 10 drops of 20% acidic acid are added to the flask, followed by 0.30 grams of potassium iodide (KI). The sample is covered with paraffin, swirled to mix the components and to ensure contact, and then allowed to sit for 20 minutes, during which time the liquor should turn yellow. The sample is then titrated with 0.002N thiosulfate until the sample turns clear. The sample is covered and allowed to sit 30 minutes before titrating once more to a clear endpoint. The level of chlorine functionality imparted to the sample was calculated to be about 519 ppm via application of the following formula:

$$\frac{( mL {Na}_{2} {S}_{2} {O}_{3} added ) ( 0.002 N {Na}_{2} {S}_{2} {O}_{3} ) ( 35.45 g \text{/} mol ) ( 1000 )}{( 2 ) ( grams of sample titrated )} = ppm {Cl}^{+}$$

### Example 2

### Antimicrobial Efficacy of BA-1 Coated PTFE Membrane Samples Against E. coli

BA-1 is obtained from HaloSource, Inc. Redmond Wash. ePTFE membrane (grade QMO12) having a mean pore size of around 0.2 microns average and 0.5 micron maximum is obtained from GE Energy, Kansas City. The ePTFE membrane was coated with BA-1 according to the methodology described in Example 1.

4-1 inch by 1 inch swatches of the BA-1 coated PTFE membranes will be utilized as carriers and placed in sterile petri plates. Two of the swatches were inoculates with 10 μl of a 1:50 washed E. coli suspension. A small amount of a detergent, e.g., Triton X-100, was added to aid in the absorption of the inoculum into the carrier. The two other swatches were then placed on top with a 25 g weight.

A timer was set for one and four hours. The petri-plates were then placed in a humidity chamber at room temperature for the desired contact time. For the challenge count, 10 μl of inoculums was added to 10 mL 0.02 sodium thiosulfate and vortexed for one minute. Dilutions 10⁻³ and 10⁻⁵ were plated onto TSA and incubated 24 hours at 37° C. After specific contact time the carriers were neutralized in 10 mL 0.02N sodium thiosulfate and vortexed for one minute. For the activated sample, dilutions 10⁻² and 10⁻⁴ were plated onto TSA. All plates were incubated overnight at 37° C. Colony counts were performed the next morning. Results are shown in Table 1.

TABLE 1

| | Contact time | | | |
|---|---|---|---|---|
| Sample | (hrs) | cfu/10 μl | LRV | % reduction |
| Control | 1 | 8.5 × 10⁴ | 0.37 | 57.29 |
| BA-1 | 1 | 2.65 × 10³ | 1.51 | 96.88 |
| Control | 4 | 4.89 × 10⁴ | 0.61 | 75.38 |
| BA-1 | 4 | 0 | 4.69 | 100 |

As shown in Table 1, the 5% BA-1 membrane was able to kill 5 log E. coli after a contact time of four hours.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The foregoing examples are illustrative of some features of the invention. The appended claims are intended to claim the invention as broadly as has been conceived and the examples herein presented are illustrative of selected embodiments from a manifold of all possible embodiments. Accordingly, it is Applicants' intention that the appended claims not limit to the illustrated features of the invention by the choice of examples utilized. As used in the claims, the word “comprises” and its grammatical variants logically also subtend and include phrases of varying and differing extent such as for example, but not limited thereto, “consisting essentially of” and “consisting of” Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations. Advances in science and technology may make equivalents and substitutions possible that are not now contemplated by reason of the imprecision of language; these variations should be covered by the appended claims.

1. An article, comprising:
a membrane having pores; and
a selectively permeable coating supported by the membrane,
wherein the selectively permeable coating comprises an effective amount of at least one antimicrobial agent.

2. The article of claim 1, wherein the membrane comprises one or more of polyalkene, polyarylene, polyamide, polyester, polysulfone, polyether, polyacrylic, polystyrene, polyurethane, polyarylate, polyimide, polycarbonate, polysiloxane, polyphenylene oxide, cellulosic polymer, or substituted derivatives thereof.

3. The article of claim 2, wherein the membrane comprises a fluorinated polymer.

4. The article of claim 3, wherein the membrane comprises a fluorinated polyolefin.

5. The article of claim 4, wherein the fluorinated polyolefin comprises one or both of polyvinylidene fluoride or polytetrafluoroethylene.

6. The article of claim 5, wherein the fluorinated polyolefin comprises expanded polytetrafluoroethylene.

7. The article of claim 1, wherein the at least one antimicrobial agent comprises one or more halamines, quaternary ammonia compounds, silver ion containing compounds, sulfonamides, N-chloro-4-methyl-, sodium salt, zinc ion containing compounds, copper ion containing compounds, chlorine releasing compounds, sodium dichloro-s-triazinetrione, trichloro-s-triazinetrione, or combinations of these.

8. The article of claim 7, wherein the at least one antimicrobial agent comprises one or more halamines.

10. The article of claim 7, wherein the antimicrobial agent comprises one or more quaternary ammonium compounds.

11. The article of claim 10, wherein the one or more quaternary ammonium compounds are polymerizable, and silicon-containing.

12. The article of claim 11, wherein the one or more quaternary ammonium salts comprise a repeating unit having the following formula:
R₃N⁺R⁰ₙSiX¹₄₋ₙY⁻
Wherein each R and each R⁰ is independently a non-hydrolysable organic group, each X¹ is —OR¹, —OH or —O—Si, wherein R¹ is an alkyl group of 1 to about 22 carbon atoms, or an aryl group of 6 carbon atoms; n is an integer of 0 to 3; and Y is halide, hydroxyl, acetate, SO₄⁻², CO₃⁻² or PO₄⁻².

13. The article of claim 12, wherein Y is a halide, each of the R groups is independently methyl, ethyl, propyl, butyl, octyl, dodecyl, tetradecyl or octadecyl; each of the R⁰ groups is independently methylenyl, ethylenyl, propylenyl, butylenyl, octylenyl, dodecylenyl, tetradecylenyl or octadecylenyl; and each X¹ is —OR¹, wherein R¹ is methyl, ethyl, propyl or butyl.

14. The article of claim 1, wherein the antimicrobial agent is present in the article in an amount in a range of from about 0.5 mg/cm² to about 50 mg/cm².

15. The article of claim 1, wherein the selective permeable coating is in the pores of the membrane.

16. The article of claim 1, wherein the selectively permeable coating comprises two or more layers, wherein at least one layer comprises at least one antimicrobial agent.

17. The article of claim 1, wherein the selectively permeable coating further comprises a polymeric component.

18. The article of claim 17, wherein the polymeric component comprises an amine or imine containing polymer.

19. The article of claim 18, wherein the amine or imine containing polymer comprises a polyvinyl alcohol-coamine.

20. The article of claim 18, wherein the polymeric component is additionally active against chemical, biological or antimicrobial agents.

21. The article of claim 20, wherein the polymeric component comprises a hydroxyalkyl-substituted polyalkyleneimine.

22. The article of claim 1, wherein the article comprises a hydrophilic coating comprising a polyvinyl nucleophilic polymer and one or both of a blocked isocyanate or a urethane.

23. The article of claim 1, wherein the article has a permeability to a chemical biological or microbial agent that is less than about 20 micrograms/cm²/24 hours for DFP.

24. An article, comprising:
a membrane having pores; and
a selectively permeable coating supported by the membrane, wherein the selectively permeable coating comprises an effective amount of at least one antimicrobial agent and an amine or imine containing polymer.

25. The article of claim 24, wherein the amine or imine containing polymer comprises at least one hydroxyalkyl-substituted polyalkyleneimine, polyvinyl alcohol-coamine, or a combination of these.

26. A laminate, comprising:
the article as defined in claim 1; and
an oleophobic membrane, wherein the article is supported on the oleophobic membrane.

27. The laminate of claim 26, wherein the antimicrobial agent comprises a plurality of nanoparticles comprising one or more halamines, quaternary ammonia compounds, silver ion containing compounds, sulfonamides, N-chloro-4-methyl-, sodium salt, zinc ion containing compounds, copper ion containing compounds, chlorine releasing compounds, sodium dichloro-s-triazinetrione, trichloro-s-triazinetrione, or combinations of these.

28. An apparel comprising the laminate of claim 26, wherein the apparel comprises outerwear having an outward facing surface capable of abrasion resistance.

29. An apparel comprising the laminate of claim 26, wherein the apparel comprises innerwear or footwear capable of being worn against exposed skin.

30. A method, comprising:
applying a selectively permeable coating to a porous membrane,
wherein the selective permeable coating comprises an effective amount of an antimicrobial agent.

31. The method of claim 30, wherein the selectively permeable coating further comprises a polymeric component and the method further comprises curing the polymeric component.
